(19) United States
(12) Patent Application Publication
(10) Pub. No.: US 2024/0082820 A1
(43) Pub. Date: Mar. 14, 2024

(54) CORE-SHELL PARTICLES HAVING A NON-POROUS CORE AND A POROUS SHELL

(71) Applicant: Waters Technologies Corporation, Milford, MA (US)

(72) Inventors: Mingcheng Xu, Lexington, MA (US); Darryl W. Brousmiche, Grafton, MA (US); Daniel P. Walsh, Danvers, MA (US); Nicole L. Lawrence, Stafford Springs, CT (US); Kevin D. Wyndham, Upton, MA (US)

(73) Assignee: Waters Technologies Corporation, Milford, MA (US)

(21) Appl. No.: 18/174,351

(22) Filed: Feb. 24, 2023

Related U.S. Application Data
(60) Provisional application No. 63/401,556, filed on Aug. 26, 2022.

(51) Int. Cl. B01J 20/281; B01J 20/28; B01J 20/32

(52) U.S. Cl. CPC B01J 20/281; B01J 20/28019; B01J 20/28071; B01J 20/28073; B01J 20/2808; B01J 20/3206; B01J 2220/54; B01J 2220/86

(57) ABSTRACT

The present disclosure pertains to core-shell particles that are superficially porous, polymer-based, and include organic-inorganic materials. In various embodiments, a non-porous polymer core is surface modified. In various embodiments, a non-porous hybrid organic-inorganic material is in contact with the modified surface of the core, and a porous hybrid organic-inorganic material is in contact with the non-porous hybrid organic-inorganic material. The present disclosure pertains to chromatographic separation devices that comprise such core-shell particles.

### CROSS-REFERENCE TO RELATED APPLICATIONS

This application claims priority to and the benefit of U.S. Provisional Application Ser. No. 63/401,556, filed Aug. 26, 2022, and entitled “Core-Shell Particles With Organic Polymer Cores And Non-Porous Hybrid Organic-Inorganic Layers.” The foregoing application is incorporated herein by reference in its entirety.

### FIELD OF TECHNOLOGY

The present technology is directed to chromatographic materials. More particularly, the present technology is directed to superficially porous composite particles for use in chromatographic separations. In general, the superficially porous composite particles comprise a non-porous polymer core, a non-porous hybrid organic-inorganic material in contact with the core, and a porous hybrid organic-inorganic shell material in contact with the non-porous hybrid organic-inorganic material.

### BACKGROUND

Chromatography is a separation process involving two phases, one stationary and the other mobile. Typically, the stationary phase is a porous or non-porous particle that is packed into a column. The mobile phase flows through the packed column. The sample, or analytes, to be separated is injected at the beginning of the column and is transported through the system by the mobile phase. In their travel through the column, the different components of the sample distribute themselves according to their relative affinity for the two phases. The results of the chromatographic separation is then depicted via a chromatogram, where the sample components can be identified by various peaks or patterns of the chromatogram.

Measuring the degree of separation between two components is commonly referred to as the resolution of each component. The resolution can be determined by efficiency, selectivity, and retention of the separation process. Efficiency refers to the quality of separation of the sample components, which is typically determined by the number of peaks that can be separated in the chromatogram. Selectivity refers to the ability of the chromatographic method to separate the components of the sample and is typically measured by a ratio of the retention of two peaks in question of the chromatogram and can be visualized as the distance between the apices of the two peaks. Retention, or retention time, refers to the time required for the sample to pass through the chromatographic column, and is typically measured as the interval of time between the injection of the sample and the detection of its components on the chromatogram.

Adjustment of mobile phase pH is a powerful tool to improve retention and selectivity in chromatographic separation of analytes, especially of ionizable analytes. A high pH mobile phase combined with elevated temperature is typically used to gain extended retention, excellent peak shape and good efficiency in reversed phase chromatographic separation of basic compounds, peptides, and biological samples. Silica-based stationary phases have been preferred in the past, due to its stability at neutral pH and high temperature. However, a common drawback is the instability of silica-based stationary phases at high pH due to particle erosion caused by dissolution, which in turn limits its use in those applications. An alternative to silica based stationary phases is to use a polymer-based stationary material. Polymer-based stationary particles have showed some promise, but also have some limitations in column efficiency, especially in the separation of small molecules.

Mass transfer and lateral diffusion properties are paramount in the high-resolution separation of small and large analytes. Compared to fully porous stationary phase particles, superficially porous particles, commonly known as core-shell particles, possess much shorter travel paths for analytes. As a result, the mass transfer caused peak broadening is minimized. Current, commercially available core-shell particles are made from silica (i.e., silica-based) and their stability in basic conditions is compromised. Accordingly, particles for use in a stationary phase that have the ability to remain stable at high pH and obtain a high-efficiency separation of analytes is desirous.

### SUMMARY OF TECHNOLOGY

The present technology is directed to superficially porous composite particles for use in chromatographic separations. In particular, the embodiments of the present technology relate to chromatographic separations of small and large biologic molecules.

The technology disclosed herein is directed to superficially porous composite particles for use in chromatographic separations (e.g., stationary phase). The superficially porous composite particles of the present technology include a non-porous inner portion and a porous exterior portion. The porous portion is typically positioned on an exterior of the superficially porous composite particles to form a shell about the non-porous inner portion. In an embodiment, the superficially porous composite particles are core-shell particles including a non-porous polymer core having a modified surface. A non-porous hybrid organic-inorganic material is deposited or formed on the modified surface of the non-porous polymer core. To provide the porosity, a porous hybrid organic-inorganic shell material is in contact with the non-porous hybrid organic-inorganic material. Embodiments of the superficially porous composite particles of the present technology can additionally feature bonding material. For example, the porous hybrid organic-inorganic shell material may be intrinsically modified (i.e., include within the shell material) with bonding material and/or an exterior surface of the porous hybrid organic-inorganic shell material may be surface modified to include bonding material on the outermost surface area of the core-shell particle. As a result of using such superficially porous particles in a stationary phase of a chromatographic separation, the superficially porous particles are able to remain stable at high pH and obtain a high-resolution separation of small molecules, such as those with a molecular weight less than 1500 dalton, or large molecules with a molecular weight above 1500 dalton.

In one aspect, the present technology is directed to a core-shell particle comprising a non-porous polymer particle core having a modified surface, a non-porous hybrid organic-inorganic material in contact with the modified surface, and a porous hybrid organic-inorganic shell material in contact with the non-porous hybrid organic-inorganic material.

The above aspect can include one or more of the following features. The non-porous polymer particle core of the core-shell particles, in some embodiments, is made from a radical polymerizable monomer or monomers. In some embodiments, the non-porous polymer particle core is made from styrene, divinylbenzene, methacrylate, or acrylonitrile. In some embodiments, the non-porous polymer particle core is made from a monomer or monomers containing at least two functional groups. In some embodiments, the non-porous polymer particle is made from monomers by condensation. In some embodiments, the monomers are carboxylic acid/alcohol or carboxylic acid/amine. In some embodiments, the non-porous polymer particle core is made from a monomer or monomers that can be polymerized by ring opening polymerization. In some embodiments, the monomers are epoxides. In some embodiments, at least a portion of a modified surface of the non-porous polymer particle core comprises at least a functional group covalently bonded to the non-porous hybrid organic-inorganic material to form a functionalized surface. In some embodiments, the functional group is at least one of organosilane, organotitanium, organozirconium characterized by C—Si, C—Ti and C—Zr bond. In some embodiments, at least a portion of the modified surface of the non-porous polymer particle core comprises at least a functional group electrostatically interacting with the non-porous hybrid organic-inorganic material to form a functionalized surface. In some embodiments, the functional group is an amide.

Additional features of the above aspect may include one or more of the following. In some embodiments, the non-porous hybrid organic-inorganic material of the core-shell particle has a thickness in the range of about 10 nm to about 200 nm. In some embodiments, the non-porous hybrid organic-inorganic material has a thickness in the range of about 25 nm to about 100 nm. In some embodiments, the non-porous hybrid organic-inorganic material has a pore volume less than 0.1 cc/g (e.g., 0.05 cc/g). In some embodiments, the non-porous hybrid organic-inorganic material comprises at least one of silica, alumina, titanium, cerium, zirconium, zirconium oxide, or a ceramic material. In some embodiments, the non-porous hybrid organic-inorganic material comprises a silicon-based hybrid organic-inorganic material.

In another aspect, the present technology is directed to a core-shell particle comprising a non-porous polymer particle core having a modified surface, a non-porous hybrid organic-inorganic material in contact with the modified surface, a porous hybrid organic-inorganic shell material in contact with the non-porous hybrid organic-inorganic material, and a bonding material in contact with the porous hybrid organic-inorganic shell material.

The above aspect can include one or more of the following features. The bonding material of the core-shell particles, in some embodiments, is incorporated within the porous hybrid organic-inorganic shell material. In some embodiments, the bonding material is further deposited upon an outer surface of the porous hybrid organic-inorganic shell material. In some embodiments, the bonding material is incorporated homogenously. In some embodiments, the bonding material is incorporated as a gradient. In some embodiments, the bonding material is further in contact with the non-porous hybrid organic-inorganic material. In some embodiments, the bonding material is incorporated within the non-porous hybrid organic-inorganic material, deposited upon an outer surface of the non-porous hybrid organic-inorganic material, or a combination thereof. In some embodiments, the bonding material is incorporated within the non-porous hybrid organic-inorganic material homogenously. In some embodiments, the non-porous hybrid organic-inorganic material as a gradient. In some embodiments, the bonding material is further in contact with the modified surface. In some embodiments, the bonding material is incorporated within the modified surface, deposited upon the modified surface, or a combination thereof. In some embodiments, the bonding material is incorporated within the modified surface homogenously. In some embodiments, the bonding material is incorporated within the modified surface as a gradient.

The present technology provides a number of advantages over current means of chromatographic separation. For instance, using a superficially porous composite particle described herein can provide a high-resolution of separation of DNA fragments. That is, a superficially porous particle, having a non-porous core with a modified surface, a non-porous hybrid organic-inorganic material in contact with the modified surface (such as, for example a silyl modified surface), and a porous hybrid organic-inorganic shell material in contact with non-porous hybrid organic-inorganic material can provide better separation of small molecules than the current means used in the industry. The present technology can remain stable at high pH. As a result, chromatographic separations using the core-shell particle described herein can lead to extended retention, better peak shape, and high efficiency separation for both small and large molecules.

### BRIEF DESCRIPTION OF THE DRAWINGS

The foregoing and other features and advantages provided by the present technology will be fully understood from the following description of exemplary embodiments when read together with the accompanying drawings.

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is a cross-sectional schematic illustration of a pore-shell composite particle, in accordance with an embodiment of the present disclosure.

FIG. 2 is a cross-sectional schematic illustration of a pore-shell composite particle, in accordance with an embodiment of the present disclosure.

FIG. 3 is a cross-sectional schematic illustration of a pore-shell composite particle, in accordance with an embodiment of the present disclosure.

FIG. 4 is a cross-sectional schematic illustration of a pore-shell composite particle, in accordance with an embodiment of the present disclosure.

FIG. 5 is a cross-sectional schematic illustration of a pore-shell composite particle, in accordance with an embodiment of the present disclosure.

FIG. 6 illustrates volume versus particle diameter, in accordance with example 2 of the present disclosure.

FIG. 7 is a scanning electron microscope photograph of particle cross-sections of the whole particles formed in accordance with sample 2C of the present disclosure.

FIG. 8 is a scanning electron microscope photograph of whole particles formed in accordance with sample 4G.

FIG. 9 is a scanning electron microscope photograph of particle cross-sections of the whole particles formed in accordance with sample 4G.

FIG. 10 is a scanning electron microscope photograph of whole particles formed in accordance with sample 4H.

FIG. 11 is a scanning electron microscope photograph of particle cross-sections of the whole particles formed in accordance with sample 4H.

FIG. 12 is a scanning electron microscope photograph of whole particles formed in accordance with sample 4I.

FIG. 13 is a scanning electron microscope photograph of particle cross-sections of the whole particles formed in accordance with sample 4I.

FIG. 14 is a scanning electron microscope photograph of whole particles made in accordance with example 3 of the present disclosure.

FIG. 15 is a magnified scanning electron microscope photograph of a whole particle made in accordance with example 3 of the present disclosure.

FIG. 16 is a scanning electron microscope photograph of whole particles formed in accordance with sample 4G of the present disclosure and then primed with poly(N-vinyl pyrrolidone).

FIG. 17 is a magnified scanning electron microscope photograph of a whole particle formed in accordance with sample 4H of the present disclosure and then primed with poly(N-vinyl pyrrolidone).

FIG. 18 is a scanning electron microscope photograph of particle cross-sections of the whole particles formed in accordance with sample 6D.

FIG. 19 is a scanning electron microscope photograph of particle cross-sections of the whole particles formed in accordance with sample 6H.

FIG. 20 is a magnified scanning electron microscope photograph of a whole particle formed in accordance with sample 6A of the present disclosure.

FIG. 21 is a scanning electron microscope photograph of whole particles formed in accordance with sample 6A of the present disclosure.

FIG. 22 is a magnified scanning electron microscope photograph of a whole particle formed in accordance with sample 6A of the present disclosure, with the addition of a porous hybrid shell material.

FIG. 23 is a scanning electron microscope photograph of whole particles formed in accordance with sample 6A of the present disclosure, with the addition of a porous hybrid shell material.

FIG. 24 is a magnified scanning electron microscope photograph of a whole particle formed in accordance with example 9.

FIG. 25 is a magnified scanning electron microscope photograph of cross-sections of particles formed in accordance with example 9.

FIG. 26 is a chromatogram providing results of a separation of a mixture of thiourea, naphthalene and acenaphthene using a column packed with the particles in accordance with example 10.

FIG. 27A is a chromatogram providing results of a separation of 18 fragments dsDNA using a column packed with conventional silica core-shell particles.

FIG. 27B is a chromatogram providing results of a separation of 18 fragments dsDNA (same sample as used in FIG. 27A) using a column packed with particles in accordance with example 10.

FIG. 28A is a chromatogram showing the results of flowing a pH=8.0 buffer through a column packed with particles in accordance with example 10 at a flow rate of 0.2 ml/min for 15 hours.

FIG. 28B is a chromatogram showing the results of flowing a pH=10.5 buffer through a column packed with particles in accordance with example 10 at a flow rate of 0.2 ml/min for 15 hours.

FIG. 28C is a chromatogram showing the results of flowing a pH=12.5 buffer through a column packed with particles in accordance with example 10 at a flow rate of 0.2 ml/min for 15 hours.

FIG. 29A is a chromatogram showing the results of flowing a pH=8.0 buffer through a column packed with silica core-shell at a flow rate of 0.2 ml/min for 15 hours.

FIG. 29B is a chromatogram showing the results of flowing a pH=10.5 buffer through a column packed with silica core-shell at a flow rate of 0.2 ml/min for 15 hours.

FIG. 29C is a chromatogram showing the results of flowing a pH=12.5 buffer through a column packed with silica core-shell at a flow rate of 0.2 ml/min for 15 hours.

### DETAILED DESCRIPTION

The present disclosure pertains to superficially porous composite particles that comprise a non-porous polymer particle core with a modified surface, a non-porous hybrid organic-inorganic material in contact with the modified surface, and a porous hybrid organic-inorganic shell material in contact with the non-porous hybrid organic-inorganic material. That is, embodiments of the present disclosure are directed to a core-shell particle including a non-porous polymer (e.g., organic material) particle core including a modified surface (e.g., a silyl modified surface of the non-porous polymer core), a hybrid organic-inorganic non-porous material in contact with the modified surface, and a porous hybrid organic-inorganic shell material in contact with the non-porous hybrid organic-inorganic material. In some embodiments, the superficially porous composite particles of the present disclosure further comprise a bonding material in contact with the modified surface, the non-porous hybrid organic-inorganic material, and/or the porous hybrid organic-inorganic shell material.

In some embodiments, the modified surface, the non-porous hybrid organic-inorganic material, the porous hybrid organic-inorganic shell material, and/or the bonding material is a silyl-modified surface comprising a first functionality (i.e., a reactive silane) and a second functionality (i.e., an organic polymerizable group). In certain embodiments, the modified surface is covalently and/or electrostatically bonded to the non-porous hybrid organic-inorganic material. In certain embodiments the non-porous hybrid organic-inorganic material includes (e.g., is intrinsically modified) with the bonding material. In certain embodiments, the bonding material is chemically and/or electrostatically bonded to the non-porous hybrid organic-inorganic material.

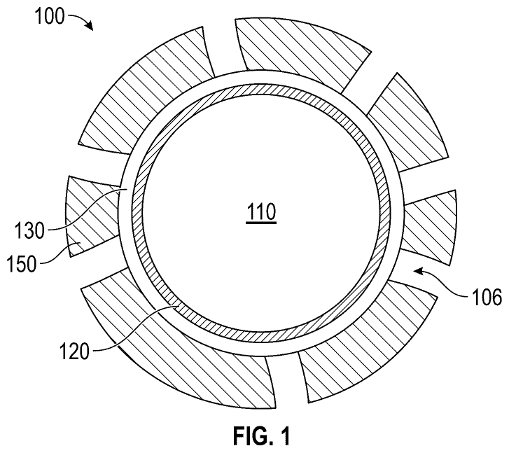

As shown in FIGS. 1-5, a core-shell particle (100; 200; 300; 400; 500) according to embodiments of the present disclosure are provided. The core-shell particles (100; 200; 300; 400; 500) have a non-porous polymer particle core (110; 210; 310; 410; 510), a modified surface (120; 220; 320; 420; 520) on the non-porous polymer particle core (110; 210; 310; 410; 510), a non-porous hybrid organic-inorganic material (130; 230; 330; 430; 530), and a porous hybrid organic-inorganic shell material (150; 250; 350; 450; 550). The porous hybrid organic-inorganic shell material (150; 250; 350; 450; 550) may be deposited or grown upon the non-porous hybrid organic-inorganic material (130; 230; 330; 430; 530). The non-porous hybrid organic-inorganic material (130; 230; 330; 430; 530) may be deposited or grown upon the modified surface (120; 220; 320; 420; 520). The modified surface (120; 220; 320; 420; 520), non-porous hybrid organic-inorganic material (130; 230; 330; 430; 530), and/or porous hybrid organic-inorganic shell material (250; 350; 450; 550) may include a bonding material (240; 340a; 340b; 440a; 440b; 540). The bonding material (240; 340a; 440a) may be bonded to and extend past an outer most surface of the porous hybrid organic-inorganic shell material (250; 350; 450). The bonding material may be formed upon the porous hybrid organic-inorganic shell material through surface derivation, the porous organic-inorganic porous shell material may be intrinsically modified with the bonding material, or a combination thereof. The bonding material may be tailored with a material tuned for a particular type of chromatographic separation mode.

The core-shell particles of the present disclosure are typically spherical. The core-shell particles of the present disclosure typically range from 1 to 14 microns in diameter, more typically, from 1 to 6 microns in diameter. Particle diameter is measured herein by Coulter Counter ((Beckman Coulter, Multisizer 4e Coulter Counter, Brea, CA, USA) by dispersing a sample in methanol containing 5% lithium chloride. A greater than 70,000 particle count is run using a 30 μm aperture in the volume mode for each sample. Using the Coulter principle, volumes of particles are converted to diameter, where a particle diameter is the equivalent spherical diameter, which is the diameter of a sphere whose volume is identical to that of the particle. Particle diameter measured as the 50% cumulative diameter of the volume based particle size distribution.

The core-shell particles of the present disclosure have good stability, even at pH's greater than 12 and less than 1, in some embodiments. For example, in an embodiment, core-shell particles in accordance with present technology exhibited less than 4% weight loss after a 12 hour exposure to an aqueous solution having a pH of 12.3. Columns packed with these core-shell particles and exposed to basic conditions showed minimum loss in separation performance.

The core-shell particles of the present disclosure are also typically narrowly dispersed in particle size. As defined herein, a collection of particles is “narrowly dispersed in particle size” when a ratio of 90% cumulative volume diameter divided by the 10% cumulative volume diameter is less than 1.4 when measured by Beckman Coulter, Multisizer 4e Coulter Counter.

### Non-Porous Polymer Core

The polymer particle cores (e.g., 110, FIG. 1) for use in the present disclosure comprise at least one organic polymer. The organic polymer cores typically contain more than 95% organic polymer, more typically more than 97.5% organic polymer, even more typically more than 99% organic polymer.

The polymer particle cores are non-porous, which is defined herein to mean that the polymer particle cores have a pore volume that is less than 0.1 cc/g. Preferably, organic polymer cores have a pore volume that is less than 0.05 cc/g, and preferably less than 0.02 cc/g, in some embodiments. Pore volume is determined using methods known in the art based on multipoint nitrogen sorption experiments (Micromeritics ASAP 2400; Micromeritics Instruments Inc., Norcross, GA).

The polymer cores typically range, for example, from 1 to 10 microns in diameter, more typically, from 1 to 5 microns in diameter. The polymer cores are typically narrowly distributed in particle size.

Elementally, polymer particle cores for use in the present disclosure include those that are composed of carbon and hydrogen, those composed of carbon, hydrogen and oxygen, those composed of carbon, hydrogen and nitrogen, and those composed of carbon, hydrogen, nitrogen and oxygen. The backbones of the organic polymer chains forming the polymer cores may contain C—C, C—O, C—N and/or O—N covalent bonds. In some embodiments (e.g., in the case of a polymer formed by radical polymerization of vinyl groups), the backbone of the at least one organic polymer chains may contain only C—C covalent bonds.

As noted above polymer cores for use in the present disclosure comprise at least one organic polymer. The at least one organic polymer comprises residues of one or more organic monomers. The one or more organic monomers residues forming the least one organic polymer may be selected from residues of hydrophobic organic monomers, residues of hydrophilic organic monomers, or a mixture of residues of hydrophobic organic monomers and residues of hydrophilic organic monomers.

Hydrophobic organic monomers may be selected, for example, from a C2-C18 olefin monomer and/or a monomer comprising a C6-C18 monocyclic or multicyclic carbocyclic group (e.g., a phenyl group, a phenylene group, naphthalene group, etc.). Specific examples of hydrophobic organic monomers include, for example, monofunctional and multifunctional aromatic monomers such as styrene, alkyl substituted styrene, halo substituted styrene, divinylbenzene, and vinylbenzyl chloride, monofunctional and multifunctional olefin monomers such as ethylene, propylene or butylene, monofunctional and multifunctional fluorinated monomers such as fluoroethylene, 1,1-(difluoroethylene), tetrafluoroethylene, chlorotrifluoroethylene, hexafluoropropylene, perfluoropropylvinylether, or perfluoromethylvinylether, monofunctional or multifunctional acrylate monomers having a higher alkyl or carbocyclic groups, for example, monofunctional or multifunctional acrylate monomers having a C6-C18 alkyl, alkenyl or alkynyl group or a C6-C18 saturated, unsaturated or aromatic carbocyclic group, monofunctional or multifunctional methacrylate monomers having a higher alkyl or carbocyclic group, for example, monofunctional or multifunctional methacrylate monomers having a C6-C18 alkyl, alkenyl or alkynyl group or a C6-C18 saturated, unsaturated or aromatic carbocyclic group, among others.

Hydrophilic organic monomers may be selected, for example, from monofunctional or multifunctional organic monomers having an amide group, monofunctional or multifunctional organic monomers having an ester group, monofunctional or multifunctional organic monomers having a carbonate group, monofunctional or multifunctional organic monomers having a carbamate group, monofunctional or multifunctional organic monomers having a urea group, monofunctional or multifunctional organic monomers having a hydroxyl group, and monofunctional or multifunctional organic monomers having a nitrogen-containing heterocyclic group, among other possibilities. Specific examples of hydrophilic organic monomers include, for example, vinyl pyridine, N-vinylpyrrolidone, N-vinyl-piperidone, N-vinyl caprolactam, lower alkyl acrylates (e.g., methyl acrylate, ethyl acrylate, etc.), lower alkyl methacrylates (e.g., methyl methacrylate, ethyl methacrylate, etc.), vinyl acetate, acrylamide or methacrylamide monomers, hydroxypolyethoxy allyl ether monomers, ethoxy ethyl methacrylate, glycidyl methacrylate, ethylene glycol dimethacrylate, methylene bisacrylamide, allyl methacrylate, or diallyl maleate.

In various embodiments, the non-porous polymer cores comprise residues of multifunctional hydrophobic organic monomers such as divinylbenzene and/or multifunctional hydrophilic organic monomers, such as ethylene glycol dimethacrylate, methylene bisacrylamide or allyl methacrylate, in order to provide crosslinks in the organic copolymer. In certain embodiments, DVB 80 may be employed, which is an organic monomer mixture that comprises divinylbenzene (80%) as well as a mixture of ethyl-styrene isomers, diethylbenzene, and can include other isomers as well.

In various embodiments, the polymer core may comprise residues of only multifunctional organic monomers. In various embodiments, the polymer may comprise residues of both multifunctional organic monomers and monofunctional organic monomers.

The present inventors have found that, in some embodiments, the porosity of a material formed from an polymer containing multifunctional organic monomer residues can be reduced by adding monofunctional organic monomer residues to the polymer, or that the porosity of a material formed from a polymer containing multifunctional organic monomer residues and monofunctional organic monomer residues can be reduced by increasing an amount of the monofunctional organic monomer residues relative to the multifunctional organic monomer residues in the polymer. For example, it has been found that polymer particle cores formed from DVB 80 (which are formed from organic polymers containing 80% multifunctional divinyl benzene monomer residues and monofunctional ethylstyrene monomer residues as explained above) have a porosity of about 0.015 cc/g, whereas organic polymer cores formed from DVB 80 and styrene (which contain multifunctional divinyl benzene monomer residues, monofunctional ethylstyrene monomer residues, and additional monofunctional styrene monomer residues) have a porosity of less than 0.007 cc/g.

In some embodiments, polymer particle cores are created in which a central region of the cores is formed from an organic copolymer containing multifunctional organic monomer residues and monofunctional organic monomer residues and an outer region of the cores is formed from an organic homopolymer containing only multifunctional organic monomer residues. In some embodiments, organic polymer cores are created in which a central region of the cores is formed from an organic copolymer containing multifunctional organic monomer residues and monofunctional organic monomer residues and an outer region of the cores is also formed from an organic copolymer containing multifunctional organic monomer residues and monofunctional organic monomer residues, but wherein a molar ratio of the multifunctional organic monomer residues relative to the monofunctional organic monomer residues is increased in the outer core region relative to the central core region. In a particular example, organic polymer cores are created in which a central region of the cores is formed from DVB and styrene and an outer region of the cores is formed from DVB. In other embodiment, the molar ratio of the multifunctional organic monomer residues relative to the monofunctional organic monomer residues is decreased in the outer core region relative to the central core region.

In various embodiments, an entire polymer particle core may be formed from an organic polymer that comprises residues of multifunctional organic monomers but does not contain resides of monofunctional organic monomers. In various embodiments, an entire polymer particle core may be formed from an organic polymer that comprises residues of both multifunctional organic monomers and monofunctional organic monomers.

The polymers forming the polymer particle cores can be prepared via a number of processes and mechanisms including, but not limited to, chain addition and step condensation processes, radical, anionic, cationic, ring-opening, group transfer, metathesis, and photochemical mechanisms. In particularly beneficial embodiments, the non-porous polymer particle cores are prepared via free radical polymerization.

The polymer particle cores of the present disclosure can be prepared in some embodiments by a dispersion polymerization process in which a homogeneous solution is formed, wherein monomers, initiator and stabilizer are combined in a solvent or solvent mixture. As polymerization proceeds, the initially formed polymers precipitate from the homogeneous solution to form nuclei. The nuclei that form still bear reactive sites such as radicals which allow them to keep growing by continuous capture and incorporation of monomers and/or oligomers from the solution.

In an exemplary process based on radical polymerization, one or more solvents and one or more stabilizers are purged with nitrogen to remove dissolved oxygen. Then, one or more monomers, including at least one multifunctional monomer, and a radical polymerization initiator are added. Radical polymerization is initiated by raising the temperature for several hours, typically under agitation. Based on the desired particle diameter, further radical polymerization initiator and further monomer may be added to the reaction mixture to allow the particle further to grow to the desired size. After reaction, the particles may be thoroughly washed and dried under vacuum.

Any radical initiator that is compatible with the organic phase may be used, either alone or in a mixture of such radical initiators. In particular embodiments, the radical initiators are capable of being heat activated or photoactivated. In specific embodiments, the radical initiator is a peroxide, a peroxyacetate, a persulfate, an azo initiator or a mixture thereof.

Where the initiator is a thermal initiator, the resulting solution may then be heated to an elevated temperature under agitation to activate the thermal initiator(s) and maintained at elevated temperature until polymerization is complete. Where the initiator is a photoinitiator, the resulting solution may then be illuminated under agitation with light having a suitable wavelength to activate the photoinitiator(s) and maintained until polymerization is complete. Suitable organic monomers for use in the organic phase are described above.

Solvent systems for the formation of polymer particle cores include methanol, ethanol, isopropanol, 2-methoxyehanol, water, acetonitrile, p-xylene, and toluene.

Stabilizers that can be employed for the formation of polymer particle cores include, for example, polyvinylpyrrolidone (PVP), non-ionic surfactants including alkylphenol ethoxylates (e.g., Triton™ N-57, available from Dow Chemical), polyvinyl alcohol (PVA) such as Selvol™ Polyvinyl Alcohol solution, available from Sekisui Special Chemicals), modified celluloses, including alkyl-modified celluloses such as methyl celluloses (e.g., Methocel™, available from DuPont) and hydrophobically modified celluloses hydroxyethylcellulose stabilizers such as Natrosol™ cetyl modified hydroxyethylcellulose (available from Ashland), and ionic surfactants including sodium alkyl sulfates such as sodium dodecyl sulfate (SDS) and sodium oleyl sulfate, among others.

In a particular embodiment of non-porous polymer particle core formation, the monomer is a combination of DVB and styrene, the initiator is 2,2′-Azobis(2-methylpropionitrile) (AIBN), the solvent system is a combination of reagent alcohol and p-xylene, and the stabilizer is polyvinyl pyrrolidone (PVP 40).

Once formed, the organic polymer cores may contain surface moieties from which further polymerization can proceed. For example, non-porous polymer particle cores formed from free radical polymerization commonly contain residual radical-polymerizable unsaturated surface moieties (e.g., ethylenyl moieties, vinyl moieties, methacryloxy moieties, or acryloxy moieties, etc.), from which further core growth can proceed. Such further polymerization may be used to increase the size of a given batch of polymer particle cores by adding an additional thickness of non-porous organic polymer to previously formed non-porous polymer particle cores.

In a particular embodiment of non-porous polymer particle core growth, the monomer is DVB, the solvent is reagent alcohol, and the stabilizer is polyvinyl pyrrolidone (PVP 40).

### Surface-Modified Non-Porous Polymer Core

In some embodiments, the application is directed to a superficially porous polymer particle with a modified surface (e.g., 120, FIG. 1). The modified surface of the non-porous polymer particle core, in some embodiments, can form a covalent or electrostatic bond with a subsequently applied non-porous hybrid organic-inorganic material. In certain embodiments, the modified surface of the non-porous polymer core is a silyl modified surface. The silyl modified surface includes a first functionality and a second functionality. For example, the first functionality is a reactive silane (e.g., alkoxy) and the second functionality is an organic polymerizable group (e.g., vinyl).

In some embodiments, the modified surface of the non-porous polymer particle core can have a thickness ranging from 1 to 300 nm, for example ranging anywhere from 1 to 3 to 10 to 30 to 100 to 300 nm (i.e., ranging between any two of the preceding values).

In some embodiments, the modified surface includes a surface polymer, which may comprise functional groups that covalently or electrostatically bond to the hybrid organic-inorganic non-porous shell. Examples of functional groups that electrostatically bond to the hybrid organic-inorganic non-porous shell include amide functional groups and amine functional groups. In this regard, the hybrid organic-inorganic non-porous materials described herein are weakly acidic in nature and thus tend to be deprotonated and negatively charged, whereas the amide functional groups or amine functional groups described herein are basic in nature and thus tend to be protonated and positively charged. Examples of functional groups that covalently bond to the hybrid organic-inorganic non-porous shell include organosilane functional groups, and organometallic functional groups such as organotitanium functional groups and organozirconium functional groups, among others. As used herein, an organosilane functional group is a functional group having at least one Si—C bond. Similarly, an organotitanium functional group is a functional group having at least one Ti—C bond, and an organozirconium functional group is a functional group having at least one Zr—C bond.

In some embodiments, the modified surface includes a surface polymer, which may comprise monomer residues that covalently or electrostatically bond to the hybrid organic-inorganic non-porous shell. Examples of monomer residues that electrostatically bond to the hybrid organic-inorganic non-porous shell include amide monomer residues and amine monomer residues. Examples of monomer residues that are covalently bonded to the hybrid organic-inorganic non-porous shell include organosilane monomer residues, organotitanium monomer residues, and organozirconium monomer residues. As used herein, an organosilane monomer residue is a monomer residue having at least one Si—C bond, an organotitanium monomer residue is a monomer residue having at least one Ti—C bond, and an organozirconium monomer residue is a monomer residue having at least one Zr—C bond.

The surface polymer may, comprise, for example, polymer chains that are grafted on the non-porous polymer core.

The surface polymer may, comprise, for example, a crosslinked polymer network that is formed on the non-porous polymer particle core.

Surface polymers can be prepared via a number of processes and mechanisms including, but not limited to, chain addition and step condensation processes, radical, anionic, cationic, ring-opening, group transfer, metathesis, and photochemical mechanisms. In particularly beneficial embodiments, the non-porous organic polymer cores are prepared via free radical polymerization.

As noted above, polymer particle cores may contain surface moieties from which further polymerization can proceed. For example, organic polymer cores formed from free radical polymerization commonly contain residual radical-polymerizable unsaturated surface moieties (e.g., ethylenyl moieties, vinyl moieties, methacryloxy moieties, acryloxy moieties, etc.), from which polymerization of the surface polymer can proceed. Polymer chains can be from monofunctional monomers. Crosslinked polymer networks can be formed from multifunctional monomers. Monofunctional monomers may be included in addition to multifunctional monomers in such crosslinked polymer networks.

As noted above, surface polymers include those comprising amide monomer residues. Examples of amide monomer residues include amide monomer residues having the formula,

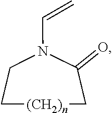

wherein n is an integer from 1-3 (i.e., N-vinyl pyrrolidone, N-vinyl-2-piperidinone or N-vinyl caprolactam). Examples of amide monomer residues also include amide monomer residues having the formula

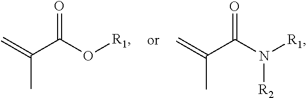

wherein R1 is selected from C1-C6 alkylene, C2-C6 alkenylene, C2-C6 alkynylene, C6-C18 arylene groups, and wherein R2 is selected from H, C1-C6 alkylene, C2-C6 alkenylene, C2-C6 alkynylene, C6-C18 arylene groups.

As also noted above, surface polymers include those comprising amine monomer residues. Examples of amine monomer residues include aminoalkyl acrylates, aminoalkyl methacrylates, dialkylaminoalkyl acrylates, or dialkylaminoalkyl methacrylates, including amino-C1-C4-alkyl acrylates, amino-C1-C4-alkyl methacrylates, di-C1-C4-alkylamino-C1-C4-alkyl acrylates, di-C1-C4-alkylamino-C1-C4-alkyl methacrylates, such as 2-aminoethyl acrylate, 2-aminoethyl methacrylate, 2-(N,N-dimethylamino)ethyl acrylate, 2-(N,N-dimethylamino)ethyl methacrylate, 2-(N,N-diethylamino)ethyl methacrylate, or 2-diisopropylaminoethyl methacrylate.

As further noted above, examples of surface polymers further include those comprising silane monomer residues that are electrostatically bonded to the hybrid organic-inorganic non-porous material. In some embodiments, the surface polymers comprise residues of one or more radical polymerizable organosilane monomers.

Specific examples of radical polymerizable organosilane monomers include unsaturated organosilane monomers (e.g., unsaturated organoalkoxysilane monomers, unsaturated organochlorosilane monomers, etc.), such as alkenyl- or alkynyl-functionalized organosilane monomers (e.g., alkenyl- or alkynyl-functionalized organoalkoxysilane monomers, alkenyl- or alkynyl-functionalized organochlorosilane monomers, etc.). Particular alkenyl-functionalized organoalkoxysilane monomers including those with vinyl groups, methacryloxy groups, and acryloxy groups. Specific examples include 3-(trimethoxysilyl)propyl methacrylate (also so known as 3-methacryloxypropyltrimethoxysilane, or MAPTMOS), methacryloxypropyltriethoxysilane, methacryloxypropyltrichlorosilane, vinyltriethoxysilane (VTES), vinyltrimethoxy silane, N-(3-acryloxy-2-hydroxypropyl)-3-aminopropyltriethoxysilane, (3-acryloxypropyl)trimethoxysilane, O-(methacryloxyethyl)-N-(triethoxysilylpropyl)urethane, N-(3-methacryl oxy-2-hydroxypropyl)-3-aminopropyltriethoxysilane, methacryloxymethyltriethoxysilane, methacryloxymethyltrimethoxysilane, methacryloxypropylmethyldiethoxysilane, methacryloxypropylmethyldimethoxysilane, methacryloxypropyltris (methoxyethoxy)s ilane, or 3-(N-styrylmethyl-2-aminoethylamino)propyltrimethoxysilane hydrochloride, among others.

In a particular embodiment of a process for forming a surface modified non-porous organic polymer core, an organosilane polymer, specifically, a poly(styryl-C1-C4-alkyl-tri-C1-C4-alkoxysilane), is formed by copolymerizing a styryl-C1-C4-alkyl-tri-C1-C4-alkoxysilane monomer where R is C1-C4 alkyl, with residual vinyl groups (e.g., residues of divinylbenzene) on a non-porous organic polymer core. Examples of styrene-based organosilane monomers include styrylethyltrimethoxysilane and styryltrimethoxysilane.

### Non-Porous Hybrid Organic-Inorganic Material

As previously noted, the present disclosure pertains to core-shell particles in which a non-porous hybrid organic-inorganic material (e.g., 130 FIG. 1) is in contact with a modified surface of a non-porous polymer core.

In some embodiments, the non-porous hybrid organic-inorganic material may have a thickness ranging for, for example, 10 nm to 200 nm, typically, from 25 nm to 100 nm. In some embodiments, the non-porous hybrid organic-inorganic material may have a pore volume, for example, less than 0.1 cc/g (e.g., 0.05 cc/g), typically, less than 0.02 cc/g.

A “hybrid organic-inorganic” material includes inorganic-based structures wherein an organic functionality is integral to both the internal or “skeletal” inorganic structure as well as the hybrid material surface. The inorganic portion of the hybrid material may be, e.g., silica, alumina, titanium, cerium, or zirconium or oxides thereof, or ceramic material. Exemplary hybrid materials are shown in U.S. Pat. Nos. 4,017,528, 6,528,167, 6,686,035, 7,175,913 and 7,919,177, the disclosures of which are hereby incorporated in their entirety.

In some embodiments, the non-porous hybrid organic-inorganic material may comprise a silicon-based hybrid organic-inorganic material that includes hybrid regions in which the silicon-based non-porous hybrid organic-inorganic material comprises silicon atoms having one or more silicon-oxygen bonds and one or more silicon-carbon bonds. In some cases, the hybrid regions may comprise a substituted or unsubstituted alkylene, alkenylene, alkynylene or arylene moiety bridging two or more silicon atoms. For example, the hybrid regions may comprise a substituted or unsubstituted C1-C18 alkylene, C2-C18 alkenylene, C2-C18 alkynylene or C6-C18 arylene moiety bridging two or more silicon atoms. In some embodiments, the hybrid regions may comprise a substituted or unsubstituted C1-C6 alkylene moiety bridging two or more silicon atoms, including methylene, dimethylene or trimethylene moieties bridging two silicon atoms. In some embodiments, the hybrid regions may comprise ≡Si—(CH2)n—Si≡ moieties, where n is an integer, and may be equal to 1, 2, 3, 4 or more. In some embodiments, the non-porous hybrid organic-inorganic material may comprise a silicon-based non-porous hybrid organic-inorganic material that further comprises inorganic regions in which the material comprises silicon atoms having four silicon-oxygen bonds, in addition to hybrid regions in which the material comprises silicon atoms having one or more silicon-oxygen bonds and one or more silicon-carbon bonds.

In various embodiments, non-porous hybrid organic-inorganic material may be formed by hydrolytically condensing one or more organosilane compounds on a modified surface of non-porous organic polymer cores, such as those described above. As used herein, an organosilane compound is a silane compound having at least one Si—C bond.

The organosilane compounds may comprise, for example, (a) one or more organosilane compounds of the formula SiZ1Z2Z3Z4, where Z1, Z2, Z3 and Z4 are independently selected from Cl, Br, I, C1-C4 alkoxy, C1-C4 alkylamino, and C1-C4 alkyl, where at least one of Z1, Z2, Z3 and Z4 is C1-C4 alkyl, examples of which include alkyl-trialkoxysilanes such as C1-C4-alkyl-tri-C1-C4-alkoxysilanes, including methyl triethoxysilane, methyl trimethoxysilane, ethyl trimethoxysilane or ethyl triethoxysilane, and dialkyl-dialkoxysilanes, for example, C1-C4-dialkyl-di-C1-C4-alkoxysilanes, such as dimethyl diethoxysilane, dimethyl dimethoxysilane, diethyl dimethoxysilane or diethyl diethoxysilane, among many other possibilities and/or (b) one or more organosilane compounds of the formula Z1Z2Z3Si—R—SiZ4Z5Z6, where Z1, Z2 and Z3 are independently selected from Cl, Br, I, C1-C4 alkoxy, C1-C4 alkylamino, and C1-C4 alkyl, although at most two of Z1, Z2 and Z3 can be C1-C4 alkyl, where Z4, Z5 and Z6 are independently selected from Cl, Br, I, C1-C4 alkoxy, C1-C4 alkylamino, and C1-C4 alkyl, although at most two of Z4, Z5 and Z6 can be C1-C4 alkyl, and where R is an organic radical, for example, selected from C1-C18 alkylene, C2-C18 alkenylene, C2-C18 alkynylene or C6-C18 arylene groups, typically, C1-C4 alkylene, typically, C1-C6 alkylene. Examples of compounds of the formula Z1Z2Z3Si—R—SiZ4Z5Z6 include bis(trialkoxysilyl)alkanes, for instance, bis (tri-C1-C4-alkoxysilyl)C1-C4-alkanes such as bis(trimethoxysilyl)methane, bis(trimethoxysilyl)ethane, bis(triethoxysilyl)methane, and bis(triethoxysilyl)ethane, among many other possibilities.

In some embodiments, one or more additional non-organosilane compounds may be hydrolytically condensed along with the one or more organosilane compounds. Such compounds include silane compounds of the formula SiZ1Z2Z3Z4, where Z1, Z2, Z3 and Z4 are independently selected from Cl, Br, I, C1-C4 alkoxy and C1-C4 alkylamino. In certain embodiments the additional silane compounds are tetra-C1-C4-alkoxysilanes such as tetramethoxysilane or tetraethoxysilane.

In some embodiments, non-porous hybrid organic-inorganic material may be formed by hydrolytically condensing the following on the modified surface of the non-porous organic polymer core as described above: (a) one or more alkyoxysilanes, for example, tetraalkoxysilanes (e.g., tetramethoxysilane (TMOS), tetraethoxysilane (TEOS), etc.) and (b) one or more organosilanes, for example, selected from bis(trialkoxysilyl)alkanes (e.g., bis(trimethoxysilyl)methane, bis(trimethoxysilyl)ethane, bis(triethoxysilyl)methane, bis(triethoxysilyl)ethane (BTEE), etc.) and/or alkyltrialkoxysilanes (e.g., methyl trimethoxysilane, methyl triethoxysilane (MTOS), ethyl triethoxysilane, etc.). Where the plurality of silane compounds comprises one or more bis(trialkoxysilyl)alkanes, alkyl-bridged non-porous hybrid organic-inorganic materials are prepared, which can offer various advantages over conventional silica-based materials, including chemical and mechanical stability. When BTEE is employed as a monomer, the resulting materials are ethylene bridged hybrid (BEH) materials. One particular BEH material can be formed from hydrolytic condensation of TEOS and BTEE.

In some embodiments, a plurality of silane compounds as described above, for example, a plurality of silane compounds comprising one or more organosilanes and one or more tetraalkoysilanes are partially condensed to form a polyalkoxyorganosiloxane oligomer, which is then hydrolytically condensed onto a surface modified non-porous organic polymer core. For example, BTEE and TEOS can be partially condensed to form a polyethoxyorganosiloxane oligomer (PEOS), which is hydrolytically condensed onto a modified surface of a non-porous organic polymer core.

In various embodiments, a non-porous hybrid organic-inorganic material may be formed by creating (typically in a series of steps) a reaction mixture comprising the following components: non-porous organic polymer cores having modified surfaces, ethanol, one or more silanes including one or more organosilanes as previously described (e.g., TEOS and BTEE, or PEOS), water, and a basic or acidic catalyst to promote silane hydrolysis and condensation of non-porous hybrid organic-inorganic material on the modified surfaces of non-porous organic polymer cores. In some embodiments, the hydrolysis proceeds at room temperature. In some embodiments, the mixture may be heated to drive the hydrolysis reaction to completion. In some embodiments, the mixture is agitated. After forming the hybrid organic-inorganic non-porous material, the resulting particles may be washed and dried.

In other embodiments, a non-porous hybrid organic-inorganic material may be formed by interaction between a template surfactant (e.g., and ionic surfactant such as cetyltrimethyl ammonium bromide (CTAB) or trioctylmethylammonium bromide (TOMB)) and one or more silanes including one or more organosilanes as previously described (e.g., TEOS and BTEE, or PEOS) during continuous addition of silanes, basic catalyst and template surfactant to surface modified non-porous organic polymer cores. This process leads to continuous silane hydrolysis and condensation of hybrid organic-inorganic reaction product on the cores. The reaction may be conducted at room temperature or at elevated temperatures.

One or more organosilanes as previously described (e.g., TEOS and BTEE, or PEOS) may be hydrolyzed in the presence of a modified surface of a non-porous (NP) organic polymer core having a surface polymer that comprises monomer residues of amide monomers and/or silane monomers such that the hydrolyzed organosilanes form a non-porous hybrid organic-inorganic material on the modified surface of the core.

### Porous Hybrid Organic-Inorganic Material

As previously noted, the present disclosure pertains to core-shell particles in which a porous hybrid organic-inorganic shell material is in contact with a non-porous hybrid organic-inorganic material, which is in contact with a modified surface of a non-porous polymer particle core. For example, as shown for core-shell particle 100 in FIG. 1, the non-porous hybrid organic-inorganic material 130 is deposited or grown upon the modified surface 120 of the non-porous polymer particle core 110, and the porous hybrid organic-inorganic shell material 150 is deposited or grown upon the non-porous hybrid organic-inorganic material 130. Pores 106 extend within the porous hybrid organic-inorganic shell material 150. As a result, particle 100 has a non-porous center portion (e.g., core 110, non-porous hybrid organic-inorganic material 130) and a porous shell portion.

The porous hybrid organic-inorganic shell material may have a pore volume that is 0.1 cc/g of shell material or greater, (e.g., 0.2 cc/g), and preferably greater than 0.65 cc/g of shell material. In various embodiments, the porous hybrid organic-inorganic shell material has a pore volume that is substantially greater than 0.15 cc/g of shell material, for example, having a pore volume ranging from 0.2 to 1.5 cc/g of shell material, preferably ranging from 0.4 to 0.75 cc/g of shell material. Thus, as compared to the hybrid material in contact with the modified surface of the polymer core, the hybrid material of the shell is porous.

In some embodiments, the porous hybrid organic-inorganic shell material may range, for example, from 0.1 to 4 microns in thickness, typically, from 0.1 to 2 microns in thickness, more typically, from 0.1 to 1.2 microns in thickness. In some embodiments, a ratio of the diameter of the cores to the diameter of the entire particles may range, for example, from 0.3:1 to 0.95:1, more typically, from 0.65:1 to 0.8:0.9.

In some embodiments, the porous hybrid organic-inorganic shell material may have a pore size ranging from 20 Å or less to 2000 Å or more, for example, ranging anywhere from 20 to 50 to 100 to 200 to 500 to 1000 to 2000 Å.

A “hybrid organic-inorganic” material includes inorganic-based structures wherein an organic functionality is integral to both the internal or “skeletal” inorganic structure as well as the hybrid material surface. The inorganic portion of the hybrid material may be, e.g., silica, alumina, titanium, cerium, or zirconium or oxides thereof, or ceramic material. Exemplary hybrid materials are shown in U.S. Pat. Nos. 4,017,528, 6,528,167, 6,686,035, 7,175,913 and 7,919,177, the disclosures of which are hereby incorporated in their entirety.

In some embodiments, the materials forming the non-porous hybrid organic-inorganic material and the porous hybrid organic-inorganic shell material maybe chemically the same or similar; the difference or distinction between the two materials being the amount of porosity. The porous hybrid organic-inorganic shell material having pore volume that is greater than 0.1 cc/g throughout the shell material, preferably greater than 0.15 cc/g throughout the shell material; whereas the non-porous hybrid organic-inorganic material has a porosity typically of 0.05 cc/g or less.

In some embodiments, the hybrid organic-inorganic shell material may comprise a silicon-based hybrid organic-inorganic material that comprises hybrid regions in which the material comprises silicon atoms having one or more silicon-oxygen bonds and one or more silicon-carbon bonds. In some cases, the hybrid regions may comprise a substituted or unsubstituted alkylene, alkenylene, alkynylene or arylene moiety bridging two or more silicon atoms. For example, the hybrid regions may comprise a substituted or unsubstituted C₁-C₁₈ alkylene, C₂-C₁₈ alkenylene, C₂-C₁₈ alkynylene or C₆-C₁₈ arylene moiety bridging two or more silicon atoms. In particular embodiments, the hybrid regions may comprise a substituted or unsubstituted C₁-C₆ alkylene moiety bridging two or more silicon atoms, including methylene, dimethylene or trimethylene moieties bridging two silicon atoms. In particular embodiments, the hybrid regions comprises may comprise ≡Si—(CH₂)ₙ—Si≡ moieties, where n is an integer, and may be equal to 1, 2, 3, 4 or more. In some embodiments, the hybrid organic-inorganic shell may comprise a silicon-based hybrid organic-inorganic material that further comprises inorganic regions in which the material comprises silicon atoms having four silicon-oxygen bonds, in addition to hybrid regions in which the material comprises silicon atoms having one or more silicon-oxygen bonds and one or more silicon-carbon bonds.

In some embodiments, the porous hybrid organic-inorganic shell material may comprise an organic-inorganic hybrid material of formula I:

(SiO₂)_{d}/[R²((R)ₚ(R¹)_{q}SiOₜ)ₘ] (I)
wherein,
R and R¹ are each independently C₁-C₁₈ alkoxy, C₁-C₁₈ alkyl, C₁-C₁₈ alkyl, C₂-C₁₈ alkenyl, C₂-C₁₈ alkynyl, C₃-C₁₈ cycloalkyl, C₁-C₁₈ heterocycloalkyl, C₅-C₁₈ aryl, C₅-C₁₈ aryloxy, or C₁-C₁₈ heteroaryl;
R² is C₁-C₁₈ alkyl, C₂-C₁₈ alkenyl, C₂-C₁₈ alkynyl, C₃-C₁₈ cycloalkyl, C₁-C₁₈ heterocycloalkyl, C₅-C₁₈ aryl, C₁-C₁₈ heteroaryl; or absent; wherein each R² is attached to two or more silicon atoms;
p and q are each independently 0.0 to 3.0;
t is 0.5, 1.0, or 1.5;
d is 0 to about 30;
m is an integer from 1-20; wherein R, R¹ and R² are optionally substituted;
provided that:
(1) when R² is absent, m=1 and

$$t = \frac{( 4 - ( p + q ) )}{2} ,$$

when 0<p+q≤3; and
(2) when R² is present, m=2-20 and

$$t = \frac{( 3 - ( p + q ) )}{2} ,$$

when p+q≤2.

In some embodiments, the hybrid organic-inorganic shell may comprise an organic-inorganic hybrid material of formula II:

(SiO₂)_{d}/[(R)ₚ(R¹)_{q}SiOₜ] (II)
wherein,
R and R¹ are each independently C₁-C₁₈ alkoxy, C₁-C₁₈ alkyl, C₁-C₁₈ alkyl, C₂-C₁₈ alkenyl, C₂-C₁₈ alkynyl, C₃-C₁₈ cycloalkyl, C₁-C₁₈ heterocycloalkyl, C₅-C₁₈ aryl, C₅-C₁₈ aryloxy, or C₁-C₁₈ heteroaryl;
d is 0 to about 30;
p and q are each independently 0.0 to 3.0, provided that when p+q=1 then t=1.5; when p+q=2 then t=1; or when p+q=3 then t=0.5.

In some embodiments, the hybrid organic-inorganic shell may comprise an organic-inorganic hybrid material of formula III:

(SiO₂)_{d}/[R²((R¹)ᵣSiOₜ)ₘ] (III)
wherein,
R¹ is C₁-C₁₈ alkoxy, C₁-C₁₈ alkyl, C₁-C₁₈ alkyl, C₂-C₁₈ alkenyl, C₂-C₁₈ alkynyl, C₃-C₁₈ cycloalkyl, C₁-C₁₈ heterocycloalkyl, C₅-C₁₈ aryl, C₅-C₁₈ aryloxy, or C₁-C₁₈ heteroaryl;
R² is C₁-C₁₈ alkyl, C₂-C₁₈ alkenyl, C₂-C₁₈ alkynyl, C₃-C₁₈ cycloalkyl, C₁-C₁₈ heterocycloalkyl, C₅-C₁₈ aryl, C₁-C₁₈ heteroaryl; or absent; wherein each R² is attached to two or more silicon atoms;
d is 0 to about 30;
r is 0, 1 or 2, provided that when r=0 then t=1.5; or when r=1 then t=1; or when r=2 then t=0.5; and
m is an integer from 1-20.

In some embodiments, the hybrid organic-inorganic shell material may comprise an organic-inorganic hybrid material of formula IV:

(A)x(B)y(C)z (IV),
wherein the order of repeat units A, B, and C may be random, block, or a combination of random and block;
A is an organic repeat unit which is covalently bonded to one or more repeat units A or B via an organic bond;
B is an organosiloxane repeat unit which is bonded to one or more repeat units B or C via an inorganic siloxane bond and which may be further bonded to one or more repeat units A or B via an organic bond;
C is an inorganic repeat unit which is bonded to one or more repeat units B or C via an inorganic bond; and
x and y are positive numbers and z is a non-negative number, wherein x+y+z=1. In certain embodiments, when z=0, then 0.002≤x/y≤210, and when z≠0, then 0.0003≤y/z≤500 and 0.002≤x/(y+z)≤210.

In some embodiments, the hybrid organic-inorganic shell material may comprise an organic-inorganic material of formula V:

(A)x(B)y(B*)y*(C)z (V),
wherein the order of repeat units A, B, B*, and C may be random, block, or a combination of random and block;
A is an organic repeat unit which is covalently bonded to one or more repeat units A or B via an organic bond;
B is an organosiloxane repeat units which is bonded to one or more repeat units B or B* or C via an inorganic siloxane bond and which may be further bonded to one or more repeat units A or B via an organic bond;
B* is an organosiloxane repeat unit which is bonded to one or more repeat units B or B* or C via an inorganic siloxane bond, wherein B* is an organosiloxane repeat unit that does not have reactive (i.e., polymerizable) organic components and may further have a protected functional group that may be deprotected after polymerization;
C is an inorganic repeat unit which is bonded to one or more repeat units B or B* or C via an inorganic bond; and
x, y, and y* are positive numbers and z is a non-negative number, wherein x+y+z=1. In certain embodiments, when z=0, then 0.002≤x/(y+y*)≤210, and when z≠0, then 0.0003≤(y+y*)/z≤500 and 0.002≤x/(y+y*+z)≤210.

In various embodiments, hybrid organic-inorganic materials may be formed by hydrolytically condensing one or more organosilane compounds on surface modified non-porous organic polymer cores, such as those described above. As used herein, an organosilane compound is a silane compound having at least one Si—C bond.

The organosilane compounds may comprise, for example, (a) one or more organosilane compounds of the formula SiZ₁Z₂Z₃Z₄, where Z₁, Z₂, Z₃ and Z₄ are independently selected from Cl, Br, I, C₁-C₄ alkoxy, C₁-C₄ alkylamino, and C₁-C₄ alkyl, where at least one of Z₁, Z₂, Z₃ and Z₄ is C₁-C₄ alkyl, examples of which include alkyl-trialkoxysilanes such as C₁-C₄-alkyl-tri-C₁-C₄-alkoxysilanes, including methyl triethoxysilane, methyl trimethoxysilane, ethyl trimethoxysilane or ethyl triethoxysilane, and dialkyl-dialkoxysilanes, for example, C₁-C₄-dialkyl-di-C₁-C₄-alkoxysilanes, such as dimethyl diethoxysilane, dimethyl dimethoxysilane, diethyl dimethoxysilane or diethyl diethoxysilane, among many other possibilities and/or (b) one or more organosilane compounds of the formula Z₁Z₂Z₃Si—R—SiZ₄Z₅Z₆, where Z₁, Z₂ and Z₃ are independently selected from Cl, Br, I, C₁-C₄ alkoxy, C₁-C₄ alkylamino, and C₁-C₄ alkyl, although at most two of Z₁, Z₂ and Z₃ can be C₁-C₄ alkyl, where Z₄, Z₅ and Z₆ are independently selected from Cl, Br, I, C₁-C₄ alkoxy, C₁-C₄ alkylamino, and C₁-C₄ alkyl, although at most two of Z₄, Z₅ and Z₆ can be C₁-C₄ alkyl, and where R is an organic radical, for example, selected from C₁-C₁₈ alkylene, C₂-C₁₈ alkenylene, C₂-C₁₈ alkynylene or C₆-C₁₈ arylene groups, typically, C₁-C₄ alkylene, typically, C₁-C₆ alkylene. Examples of compounds of the formula Z₁Z₂Z₃Si—R—SiZ₄Z₅Z₆ include bis(trialkoxysilyl)alkanes, for instance, bis(tri-C₁-C₄-alkoxysilyl)C₁-C₄-alkanes such as bis(trimethoxysilyl)methane, bis(trimethoxysilyl)ethane, bis(triethoxysilyl)methane, and bis(triethoxysilyl)ethane, among many other possibilities.

In some embodiments, one or more additional non-organosilane compounds may be hydrolytically condensed along with the one or more organosilane compounds. Such compounds include silane compounds of the formula SiZ₁Z₂Z₃Z₄, where Z₁, Z₂, Z₃ and Z₄ are independently selected from Cl, Br, I, C₁-C₄ alkoxy and C₁-C₄ alkylamino. In certain embodiments the additional silane compounds are tetra-C₁-C₄-alkoxysilanes such as tetramethoxysilane or tetraethoxysilane.

In some embodiments, porous hybrid organic-inorganic shell materials may be formed by hydrolytically condensing the following on the non-porous hybrid organic-inorganic material described above: (a) one or more alkyoxysilanes, for example, tetraalkoxysilanes (e.g., tetramethoxysilane (TMOS), tetraethoxysilane (TEOS), etc.) and (b) one or more organosilanes, for example, selected from bis(trialkoxysilyl)alkanes (e.g., bis(trimethoxysilyl)methane, bis(trimethoxysilyl)ethane, bis(triethoxysilyl)methane, bis(triethoxysilyl)ethane (BTEE), etc.) and/or alkyltrialkoxysilanes (e.g., methyl trimethoxysilane, methyl triethoxysilane (MTOS), ethyl triethoxysilane, etc.). Where the plurality of silane compounds comprises one or more bis(trialkoxysilyl)alkanes, alkyl-bridged hybrid organic-inorganic materials are prepared, which can offer various advantages over conventional silica-based materials, including chemical and mechanical stability. When BTEE is employed as a monomer, the resulting materials are ethylene bridged hybrid (BEH) materials. One particular BEH material can be formed from hydrolytic condensation of TEOS and BTEE.

In some embodiments, a plurality of silane compounds as described above, for example, a plurality of silane compounds comprising one or more organosilanes and one or more tetraalkoysilanes are partially condensed to form a polyalkoxyorganosiloxane oligomer, which is then hydrolytically condensed onto the non-porous hybrid organic-inorganic material. For example, BTEE and TEOS can be partially condensed to form a polyethoxyorganosiloxane oligomer (PEOS), which is hydrolytically condensed onto the non-porous hybrid organic-inorganic material.

In various embodiments, a porous hybrid organic-inorganic shell material may be formed by creating (typically in a series of steps) a reaction mixture comprising the following components: non-porous organic polymer cores having modified surfaces and a non-porous hybrid organic-inorganic material in contact with the modified surface (i.e., starting non-porous particle), ethanol, one or more porogens, one or more silanes including one or more organosilanes as previously described (e.g., TEOS and BTEE, or PEOS), water, and a basic or acidic catalyst to promote silane hydrolysis and condensation of hybrid organic-inorganic material on the outer most portion of the starting non-porous particle. In some embodiments, the hydrolysis proceeds at room temperature. In some embodiments, the mixture may be heated to drive the hydrolysis reaction to completion. In some embodiments, the mixture is agitated. After forming the hybrid organic-inorganic shell material, the resulting particles may be washed and dried. In general, porosity is introduced through extraction, degradation, or evaporation of the porogen.

Examples of porogens include the following: water immiscible organic solvents such as toluene, non-ionic surfactants including aromatic polyoxyethylene surfactants such as Triton™ surfacants, polyoxyethylene-polyoxypropylene block copolymers such as Pluronic™ surfactants, and ionic surfactants such as cetyltrimethyl ammonium bromide (CTAB) and trioctylmethylammonium bromide (TMAB), polyphenolic compounds such tannic acid, and organic polymers such as polystyrene.

Examples of basic catalysts include hydroxide salts such as potassium hydroxide, sodium hydroxide or ammonium hydroxide, amines such as octylamine, N,N-Dimethylhexadecylamine, and dodecylamine).

In other embodiments, a porous hybrid organic-inorganic shell material may be formed by interaction between a template surfactant (e.g., and ionic surfactant such as cetyltrimethyl ammonium bromide (CTAB) or trioctylmethylammonium bromide (TOMB)) and one or more silanes including one or more organosilanes as previously described (e.g., TEOS and BTEE, or PEOS) during continuous addition of silanes, basic catalyst and template surfactant to surface modified non-porous organic polymer cores. This process leads to continuous silane hydrolysis and condensation of hybrid organic-inorganic reaction product on the cores. The reaction may be conducted at room temperature or at elevated temperatures. A porous hybrid organic-inorganic shell material is formed upon subsequent removal of the template surfactant.

In some embodiments, one or more organosilanes, as previously described (e.g., TEOS and BTEE, or PEOS), may be hydrolyzed in the presence of a porogen and the starting non-porous particle which has a surface polymer that comprises monomer residues of amide monomers and/or silane monomers such that the hydrolyzed organosilanes form a hybrid organic-inorganic material on the core. Upon removal of the porogen, a porous hybrid organic-inorganic shell material is formed.

### Bonding Material

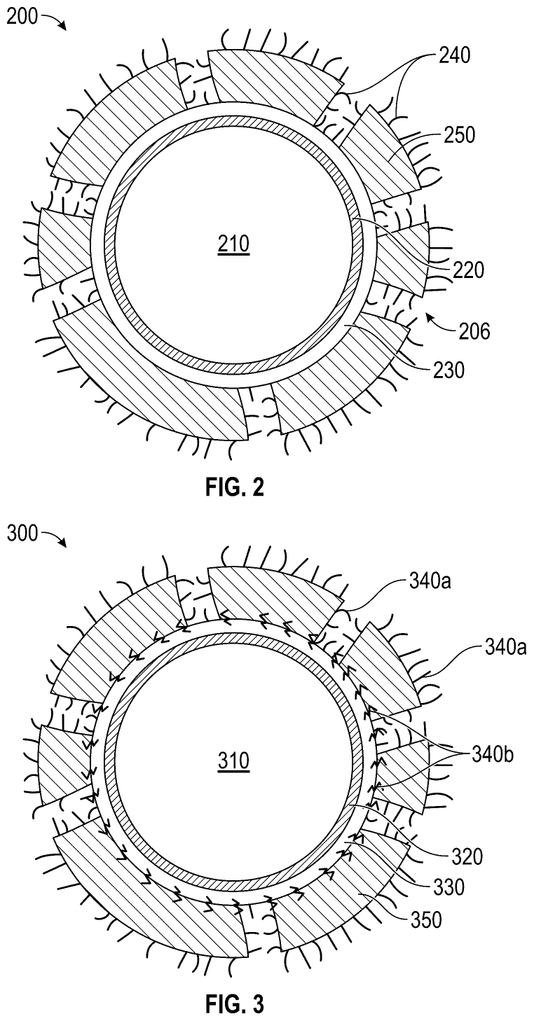

As previously noted, in some embodiments, the core-shell particles as disclosed herein may additionally include a bonding material, which modifies one or more portions of the core-shell particles. For example, the modified surface, non-porous hybrid organic-inorganic material, and/or porous hybrid organic-inorganic shell material may be modified with the bonding material. The modification may be intrinsic modification (i.e., including the bonding material when depositing or growing a portion of the particle), surface modification (i.e., applying the modification to an exposed surface of the particle), or a combination thereof. A shown in FIG. 2, in embodiment (particle 200), porous hybrid organic-inorganic shell material 250 is surface modified with bonding material 240; forming a layer or region extending from the porous hybrid organic-inorganic shell material 250. The porous hybrid organic-inorganic shell material 250 is at least partially in contact with a non-porous hybrid organic-inorganic material 230. The non-porous hybrid organic-inorganic material 230 may not be in contact with the porous hybrid organic-inorganic shell material 250 where pores 206 of the porous hybrid organic-inorganic shell material 250 extend to the surface of the non-porous hybrid organic-inorganic material 230. Where the non-porous hybrid organic-inorganic material 230 is not in contact with the porous hybrid organic-inorganic shell material 250, the non-porous hybrid organic-inorganic material 230 may also be surface modified with the bonding material 240. In some cases, the bonding material 240 covalently or electrostatically bonds to the porous hybrid organic-inorganic shell material 250 and/or the non-porous hybrid organic-inorganic material 230. As can be seen in FIG. 2, the modified surface 220 of the non-porous polymer core 210 is in contact with the non-porous hybrid organic-inorganic material 230 which is additionally in contact partially with the porous hybrid organic-inorganic shell material 250. The bonding material 240 is in contact with the non-porous hybrid organic-inorganic material 230 (where the non-porous hybrid organic-inorganic material 230 is not in contact with the porous hybrid organic-inorganic shell material 250, i.e., within pores 206) and the porous hybrid organic-inorganic shell material 250.

In another embodiment (particle 300), and as shown in FIG. 3, the porous hybrid organic-inorganic shell material 350 is surface modified with bonding material 340a. In addition, the non-porous hybrid organic-inorganic material 330 and the porous hybrid organic-inorganic shell material 350 are intrinsically modified with bonding material 340b. That is, the bonding material 340b is included in at least a portion of the non-porous hybrid organic-inorganic material 330 and in the porous hybrid-inorganic shell material 350. In some embodiments (not shown), the bonding material 340b can be included within the porous hybrid organic-inorganic shell material 350 and/or the non-porous hybrid organic-inorganic material 330 as a gradient (i.e., concentration of bonding material 340b varying through thickness). The non-porous hybrid organic-inorganic material 330 (where not in contact with the porous hybrid organic-inorganic shell material 350) and porous hybrid organic-inorganic shell material 350 are additionally surface modified with the bonding material 340a. As can be seen from FIG. 3, the non-porous hybrid organic-inorganic material 330 is in contact with the porous hybrid organic-inorganic shell material 350, and both the non-porous hybrid organic-inorganic material 330 and the porous hybrid organic-inorganic shell material 350 are in contact (e.g., have been modified) with the bonding material 340a and 340b.

In some embodiments, the bonding material 340b included in the non-porous hybrid organic-inorganic material 330 and the porous hybrid organic-inorganic shell material 350 is the same as the bonding material 340a that is added after growth of the porous hybrid organic-inorganic shell material 350. That need not be the case, however. In some embodiments, the bonding material 340b within the nonporous hybrid organic-inorganic material 330 is different than the bonding material 340a that is added after growth of the porous hybrid organic-inorganic shell material 350 (e.g., an end cap is supplied outside of shell material 330, or a charge is added to create a charged surface).

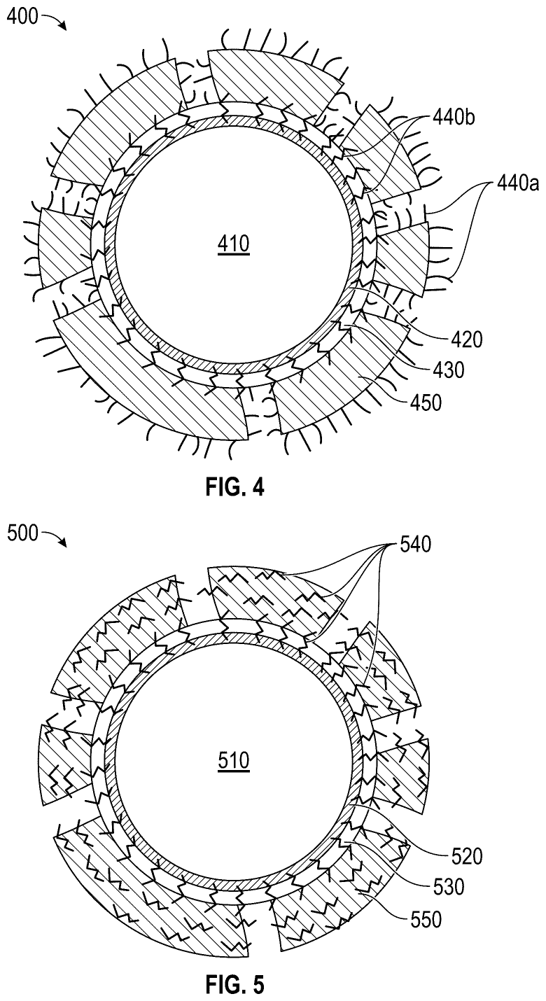

In another embodiment (particle 400 shown in FIG. 4), the porous hybrid organic-inorganic shell material 450 is surface modified with bonding material 440a. In addition, the modified surface 420, the non-porous hybrid organic-inorganic material 430, and the porous organic-inorganic shell material 550 are intrinsically modified with bonding material 440b. That is, the bonding material 440b extends at least partially through the non-porous hybrid organic-inorganic shell material 450, the porous hybrid organic-inorganic material 430, and the modified surface 420. In some embodiments (not shown), the bonding material 440b can be included within the porous hybrid organic-inorganic shell material 450 and/or the non-porous hybrid organic-inorganic material 430 as a gradient (i.e., concentration of bonding material 440b varying through thickness of particle 400). In the particle 400 shown in FIG. 4, the non-porous hybrid organic-inorganic material 430 (where not in contact with the porous hybrid organic-inorganic shell material 450) and porous hybrid organic-inorganic shell material 450 are additionally surface modified with the bonding material 440a. As can be seen from FIG. 4, the modified surface 420 is in contact with the non-porous hybrid organic-inorganic material 430, both of which are in contact with the bonding material 440b. The non-porous hybrid organic-inorganic material 430 is also in contact with the porous hybrid organic-inorganic shell material 450, both of which are in contact (e.g., have been modified) with the bonding material 440a and 440b.

In some embodiments, the bonding material 440b extending within the modified surface 420 and the non-porous hybrid organic-inorganic material 430 is the same as the bonding material 440a extending beyond the surface of the porous hybrid organic-inorganic material shell material 450. That need not be the case, however. In some embodiments, the bonding material 440b extending within the modified surface 420 and the non-porous hybrid organic-inorganic material 430 is different from the bonding material 440a extending beyond the surface of the porous hybrid organic-inorganic shell material 450 (e.g., an end cap is supplied outside of material 450, or a charge is added to create a charged surface).

Although FIG. 4 shows particle 400 with bonding material 440a added after growth of the porous hybrid organic-inorganic shell material 450, this need not be the case. As shown in FIG. 5, in another embodiment, each of the modified surface 520, the non-porous hybrid organic-inorganic material 530, and the porous hybrid organic-inorganic shell material 550 of particle 500 is intrinsically modified with bonding material 540. That is, the bonding material 540 is included in at least a portion of the modified surface 520, in at least a portion of the non-porous hybrid organic-inorganic material 530, and in at least a portion of the porous hybrid organic-inorganic shell material 550. As can be seen from FIG. 5, the modified surface 520 is in contact with the non-porous hybrid organic-inorganic material 530, which is also in contact with the porous hybrid organic-inorganic shell material 550, all of which are in contact with the bonding material 540. In some embodiments, the bonding material 540 is included with a varying concentration (e.g., gradient) within the non-porous hybrid organic-inorganic material 530 and/or within the porous hybrid organic-inorganic shell material 540.

In some embodiments, the bonding material 540 included in the modified surface 520 and the non-porous hybrid organic-inorganic material 530 is the same as the bonding material 540 extending beyond the surface of the non-porous hybrid organic-inorganic material 530 (where not in contact with the porous hybrid organic-inorganic shell material 550, i.e., within a pore). That need not be the case, however. In some embodiments, the bonding material 540 extending within the modified surface 520 and the non-porous hybrid organic-inorganic material 530 is different from the bonding material 540 extending beyond the surface of the non-porous hybrid organic-inorganic material 530 (i.e., within a pore). For example, an end cap is supplied outside of material 530, or a charge is added to create a charged surface to change or tailor the functionality of the bonding material.

The bonding material may be functionalized (e.g., tailored or tuned) for particular chromatographic separations or modes (Slalom, HDC, IP-RPLC, WAX). In some cases, at least a portion of the bonding material is a silane. The bonding material may be hydrophobic, hydrophilic, positively and/or negatively charged, or a combination thereof. In some cases, at least a portion of the bonding material may be an ionizable silane. The bonding material may include, but is not limited to, alkyl groups (e.g., C1 to C20), polyethylene glycols, hydrophilic polymers based on acrylamide and (meth)acrylate, polar groups containing nitride, nitrile, hydroxyl, negatively and/or positively charged groups, amino, chloro, or alkoxysilanes, or combinations thereof.

In some embodiments, the bonding material may be incorporated into core-shell particle homogenously, with the bonding material deposited in sync (i.e., intrinsically modified) and/or after the modified surface, the non-porous hybrid organic-inorganic material, and/or the porous hybrid organic-inorganic shell material is deposited. The bonding material may be incorporated into the core-shell particle as a gradient, with the bonding material deposited after the modified surface, the non-porous hybrid organic-inorganic material, and/or the porous hybrid organic-inorganic shell material has started, but before deposition of that particular region of the particle (e.g., 520, 530, 550) has ended. In some embodiments, the modified surface, the non-porous hybrid organic-inorganic material, and/or the porous hybrid organic-inorganic shell material may have a concentration or amount of bonding material that varies along a thickness of the surface and/or material. In some cases, the bonding material may be incorporated into the modified surface (e.g., a silyl modified surface) of the non-porous polymer particle core as a silane-based bonding. (See, for example US Patent Publication US 2019/0322783.) In some cases, at least a portion of the bonding material is a silane. The bonding material may be hydrophobic, hydrophilic, positively and/or negatively charged, or a combination thereof. In some cases, at least a portion of the bonding material may be an ionizable silane to form a functionalized surface.

As used herein the term “gradient” refers to the composition of the particles as viewed from the direction of the center of the particle to the particle surface. In a gradient material, the composition of the material is varied based on the order and concentration of monomers added in a predetermined pattern such that there is composition variance along the radius of the particle but without the formation of discrete shells of material. For example, the material(s) of the polymer particles may have a unique gradient composition across the radius from the particle nucleus to the outermost surface, wherein the composition gradient includes, but not limited to, hydrophobic/hydrophilic gradient, crosslinking ratio gradient, functional group gradient, charge ratio gradient, density gradient, or a combination thereof.

In some embodiments, divinylbenzene may be used to synthesize the non-porous polymer particle core. In some cases, the surface of the divinylbenzene particle core may be modified with a styrenic trimethoxysilane. In some cases, the modified divinylbenzene particle core surface may be then coated with an ethylene bridge hybrid (hybrid organic-inorganic) compound and bonded to achieve base stable particles for chromatographic bio-molecular separations.

Potential advantages of the core-shell particles of the present disclosure include improvements in mass transfer and increased efficiencies relative to fully porous particles or fully non-porous particles, improved pH stability, and the ability to form an array of particle and pore sizes. The core-shell particles can be used as chromatography packing materials for the separation of both small molecules and large biologics.

### Chromatographic Devices

In some aspects of the present disclosure, the core-shell particles described herein may be provided in a suitable chromatographic device. For this purpose, the core-shell particles described herein may be provided in conjunction with a suitable housing. The core-shell particles and the housing may be supplied independently, or the core-shell particles may be pre-packaged in the housing. Housings for use in accordance with the present disclosure commonly include a chamber for accepting and holding core-shell particles. In various embodiments, the housings may be provided with an inlet and an outlet leading to and from the chamber.

Suitable construction materials for the chromatographic housings include inorganic materials, for instance, metals such as stainless steel and ceramics such as glass, as well as synthetic polymeric materials such as polyethylene, polypropylene, polyether ether ketone (PEEK), and polytetrafluoroethylene, among others.

In certain embodiments, the chromatographic housings may include one or more filters which act to hold the core-shell particles in a housing. Exemplary filters may be, for example, in a form of a membrane, screen, frit or spherical porous filter.

In certain embodiments, the chromatographic device is a chromatographic column.

The present disclosure also provides for a kit comprising the core-shell particles, housings or devices as described herein and instructions for use. In one embodiment, the instructions are for use with a separation device, e.g., a chromatographic column.

### Chromatographic Separations

In some aspects of the present disclosure, the core-shell particles of the present disclosure can be used in a variety of chromatographic separation methods. As such, the chromatographic devices and chromatographic kits described herein can also be utilized for such methods. Examples of chromatographic separation methods in which the core-shell particles of the invention can be used include used in both high-pressure liquid chromatography (HPLC) and ultra-high pressure liquid chromatography (UHPLC) in different modes. Those modes include, but are not limited to, affinity separation, hydrophilic interaction chromatography (HILIC) separations, normal-phase separations, reversed-phase separations, chiral separations, supercritical fluid chromatography SFC separations, perfusive separations, size-exclusion chromatography (SEC) separations, ion exchange separations, or multimode separations.

The core-shell particles, devices and kits of the present disclosure may be used for chromatographic separations of small molecules, carbohydrates, antibodies, whole proteins, peptides, and/or DNA, among other species.

Such chromatographic separations may comprise loading a sample onto core-shell particles in accordance with the present disclosure and eluting adsorbed species from the core-shell particles with a mobile phase.

Such chromatographic separations may be performed in conjunction with a variety of aqueous and/or organic mobile phases (i.e., in mobile phases that contain water, an organic solvent, or a combination of water and organic solvent) and in conjunction with a variety of mobile phase gradients, including solvent species gradients, temperature gradients, pH gradients, salt concentration gradients, or gradients of other parameters.

The following examples are provided to illustrate how to make composite particles and their components in accordance with the present technology. The examples are provided for illustrative purposes only and should not be considered to be limiting. When an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the present technology be limited to the specific values recited when defining a range.

### EXAMPLE 1. NON-POROUS POLY(DVB80) PARTICULATE CORE

In this example, an exemplary core-shell composite particle that is particularly beneficial in separation of small molecules is manufactured. Specifically, various composite particles are manufactured with differing particle size. Other processes and other materials can be utilized for making the core-shell composite particle of the present technology.

The inhibitor in divinylbenzene (80%, technical grade) used in the particle synthesis was removed by passing the monomer through an alumina cartridge.

Primary particle synthesis: In this particle synthesis experiment (sample 1A in Table 1 below), 65.1 grams of PVP-40, 8.9 grams of Triton N-57, 2452.6 grams of reagent alcohol (905 ethanol, 5% methanol and 5% isopropanol) and 153.3 grams g of p-xylene were charged into a 4 L cylinder flask reactor equipped with mechanical agitation, condenser and thermocouple. The mixture was mixed with agitation at 200 RPM and the dissolved oxygen in the solution was removed by sub-surface purging with nitrogen. After dissolved oxygen is below 1 ppm, 2.1 grams of azobisisobutyronitrile and 105 grams of divinylbenzene was charged into the reaction. The reaction temperature was raised to 70° C. and held at this temperature for 20 hrs.

Primary core growth: When 20 hours of reaction time was reached, the temperature was maintained at 70° C. and 1.8 grams of azobisisobutyronitrile was added. Subsequently, a solution of 67.6 grams of divinylbenzene and 20.3 grams of PVP-40 in 202.7 grams of reagent alcohol was metered in via a pump at a constant flow rate over 120 minutes. The reaction was continued at 70° C. for at least 12 hours. After reaction, the particles were separated from the reaction slurry by filtration, followed by washing sequentially with methanol, tetrahydrofuran (THF) and acetone. The final product was dried in vacuum oven at 45° C. overnight. Approximately 147 grams of 1.95 μm particles were obtained.

To test the effect of adjusting the amount of PVP-40 in the beginning of the reaction, three different amounts (65.1 g—sample 1A; 48.9 g—sample 1B; and 109.2 g—sample 1c) were evaluated. Table 1 below provides the results, which indicate that particle size is inversely related to the amount of PVP-40. Example 1A to example 1C describe the synthesis of poly(DVB80) particles with different particle size by adjusting the amount of PVP-40 in the beginning of the reaction. Example 2A to example 2C describe the synthesis of poly(DVB80-co-styrene) particles different DVB80 and styrene composition by adjusting the amount of DVB80 and styrene charged in the primary core synthesis step of core growth step.

TABLE 1

| | PVP-40, | Particle size, | Specific surface area, | Pore volume, |
|---|---|---|---|---|
| Sample | g | μm | m²/g | cc/g |
| 1A | 65.1 | 1.95 | 36.0 | 0.04 |
| 1B | 48.9 | 2.22 | 30.8 | 0.03 |
| 1C | 109.2 | 1.27 | 38.5 | 0.04 |

### EXAMPLE 2. NON-POROUS POLY(DVB80-CO-STYRENE) PARTICULATE CORE

In this example, an exemplary non-porous core is manufactured which includes a polymer core including two different polymers. Other processes and other materials can be utilized for making the non-porous polymer core of the composite particles of the present technology.

The inhibitor in both divinylbenzene (80%, technical grade) and styrene used in the particle synthesis was removed by passing the monomers through an alumina cartridge.

Primary particle synthesis: In this particle synthesis experiment (sample 2A) 78.2 grams of PVP-40, 8.9 grams of Triton N-57, 2452.6 grams of reagent alcohol (905 ethanol, 5% methanol and 5% isopropanol) and 153.3 grams g of p-xylene were charged into a 4 L cylinder flask reactor equipped with mechanical agitation, condenser and thermocouple. The mixture was mixed with agitation at 200 RPM and the dissolved oxygen in the solution was removed by sub-surface purging with nitrogen. After dissolved oxygen is below 1 ppm, 2.1 grams of azobisisobutyronitrile, 42 grams of divinylbenzene (80%, technical grade) and 63.0 grams of styrene were charged into the reaction. The reaction temperature was raised to 70° C. and held at this temperature for 20 hrs.

Primary core growth: When 20 hours of reaction time was reached, the temperature was maintained at 70° C. and 1.8 grams of azobisisobutyronitrile was added. Subsequently, a solution of 67.6 grams of divinylbenzene and 19.2 grams of PVP-40 in 192.0 grams of reagent alcohol was metered in via a pump at a constant flow rate over 120 minutes. The reaction was continued at 70° C. for at least 12 hours. After reaction, the particles were separated from the reaction slurry by filtration, followed by washing sequentially with methanol, tetrahydrofuran (THF) and acetone. The final product was dried in vacuum oven at 45° C. overnight. Approximately 135 grams of 2.2 μm particles were obtained.

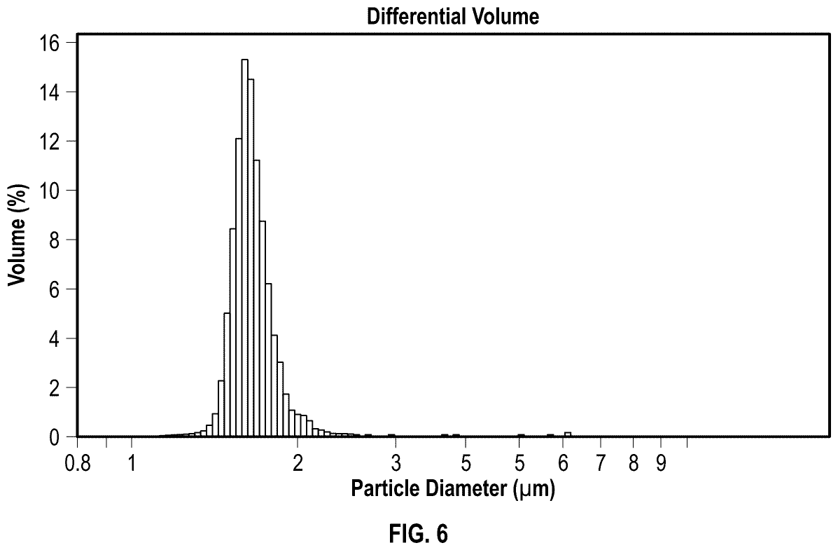

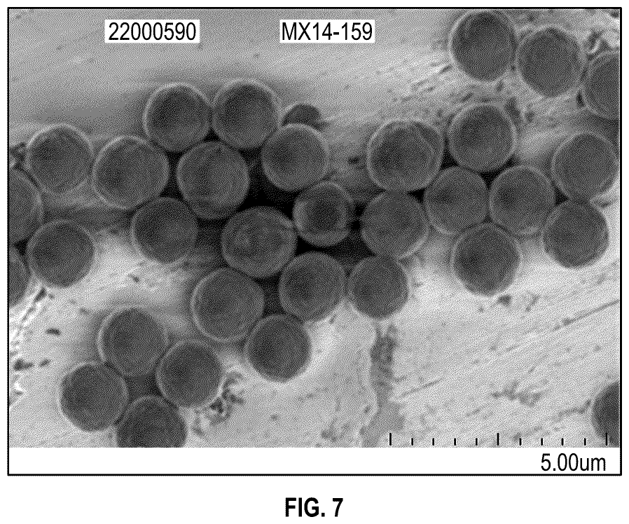

Below, in Table 2, samples 2A to 2C describe the synthesis of poly(DVB80-co-styrene) particles with different DVB80 and styrene compositions by adjusting the amount of DVB80 and styrene charged in the primary core synthesis step of the core growth step. The particle size distribution of poly(DVB80-co-styrene) of sample 2C is described in the graph of FIG. 6 and an micrograph image of the particles is depicted in FIG. 7.

TABLE 2

| | Primary core | | Primary core | | | Specific | |
|---|---|---|---|---|---|---|---|
| | synthesis | | growth | | Particle | surface | Pore |
| Sam- | DVB80, | Styrene, | DVB80, | Styrene, | size, | area | volume |
| ple | g | g | g | g | μm | m²/g | cc/g |
| 2A | 42.0 | 63.0 | 67.6 | 0.0 | 2.07 | 8.2 | 0.010 |
| 2B | 63.0 | 42.0 | 38.4 | 25.6 | 1.72 | 2.1 | 0.005 |
| 2C | 105.0 | 0.0 | 30.5 | 20.3 | 1.63 | 6.3 | 0.008 |
| 2D | 57.8 | 47.2 | 63.7 | 0.0 | 2.32 | 18.4 | 0.02 |

### EXAMPLE 3. LARGER PARTICULATE CORE MADE FROM ANOTHER SMALLER CORE

In this example, an exemplary non-porous core, which includes a core made in two stages is manufactured. Other processes and other materials can be utilized for making the non-porous polymer core of the composite particles of the present technology.

120 grams of particle (particle size, 2.32 μm) made by the method described in sample 2D, were re-dispersed in a solution containing 37.0 grams of PVP-40, 4.5 grams g of TritonTM N-57, 100.0 grams of p-xylene and 1234.0 grams of reagent alcohol (90% ethanol, ˜5% methanol and ˜5% isopropanol), then charged into a 4 liter kettle reactor equipped with mechanical agitation, condenser reactor and thermocouple. The slurry was mixed at 200 RPM and purged with nitrogen via subsurface to obtain a dissolved oxygen below 1 ppm. Once the dissolved oxygen in the solution is less than 1 ppm, the nitrogen subsurface sparging was changed to blanket sparging, the agitation speed was adjusted to 75 RPM and then the reaction temperature was raised to 70° C. When the reaction temperature reached 70° C., 4.8 grams of divinylbenzene (80%, inhibitor was removed with aluminum oxide) and 3.0 grams of AIBN were added. 15 minutes later, a solution containing 139.5 grams of divinylbenzene (80%, inhibitor was removed with aluminum oxide), 105.6 grams of PVP-40 and 1345.7 grams of reagent alcohol was added via a pump at a constant rate over 2 hours. After addition, the reaction was held for 20 hours at 70° C. After reaction, the particles were separated from the reaction slurry by filtration. The particles were washed with methanol, followed with tetrahydrofuran (THF), and lastly with acetone. The final product was dried in vacuum oven at 45° C. overnight. 250 grams of monodisperse 3.0 μm particles were obtained.

### EXAMPLE 4. CORE SURFACE PRIME WITH SILANE FUNCTIONALITY

In this example, an exemplary primed, non-porous core is manufactured. Other processes and other materials can be utilized for making the primed, non-porous polymer core of the composite particles of the present technology.

The inhibitor in both divinylbenzene (80%, technical grade) and styryl ethyltrimethoxysilane was removed by passing through an alumina cartridge. The reagent alcohol used in the reaction contained 90% ethanol, ˜5% methanol and ˜5% isopropanol. In this particle synthesis experiment (see sample 4A in Table 3 below), 44.7 grams of PVP-40, 165.2 grams g of p-xylene were charged into a 4 L round bottom flask reactor equipped with mechanical agitation, condenser reactor and thermocouple. A slurry of 145.0 grams of particles (sample 1A, from example 1) in 1490.7 grams of reagent alcohol was added. The mixture was mixed at 200 RPM for 24 hours. Then the reaction slurry was purged with nitrogen via sub-surface to obtain a dissolved oxygen below 1 ppm. Once the dissolved oxygen in the solution is less than 1 ppm, the reaction mixture was heated to 70° C. and the agitation speed was adjusted to 75 RPM. Then, 2.9 grams of divinylbenzene and 2.5 grams of 2,2′-Azobis(2-methylpropionitrile) (AIBN) were added. After 15 minutes of mixing, a solution containing 14.5 grams of styryl ethyltrimethoxysilane, 1.5 grams of divinylbenzene and 13.9 grams of PVP-40 in 464.0 grams of reagent alcohol was added at a constant flow rate over 2 hours. After the reaction was held at 70° C. for a total of 20 hrs, the reaction was cooled to below 40° C. and the produced particles were separated from the reaction slurry by filtration. The particles were washed with methanol, followed with tetrahydrofuran (THF), and lastly with acetone. The final product was dried in vacuum oven at 45° C. overnight. 149.0 grams of primed particles were obtained.

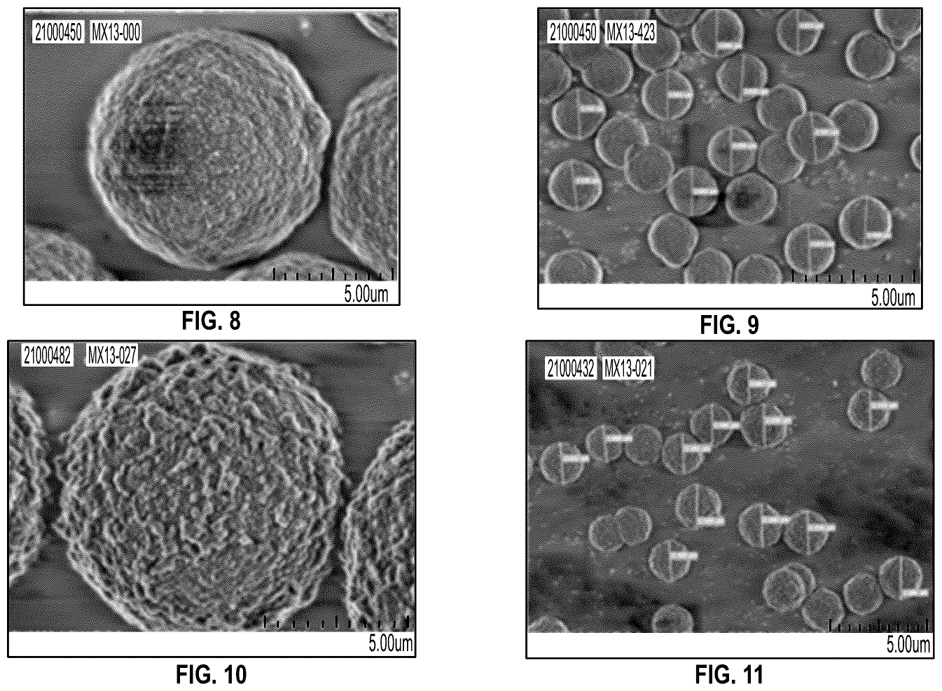

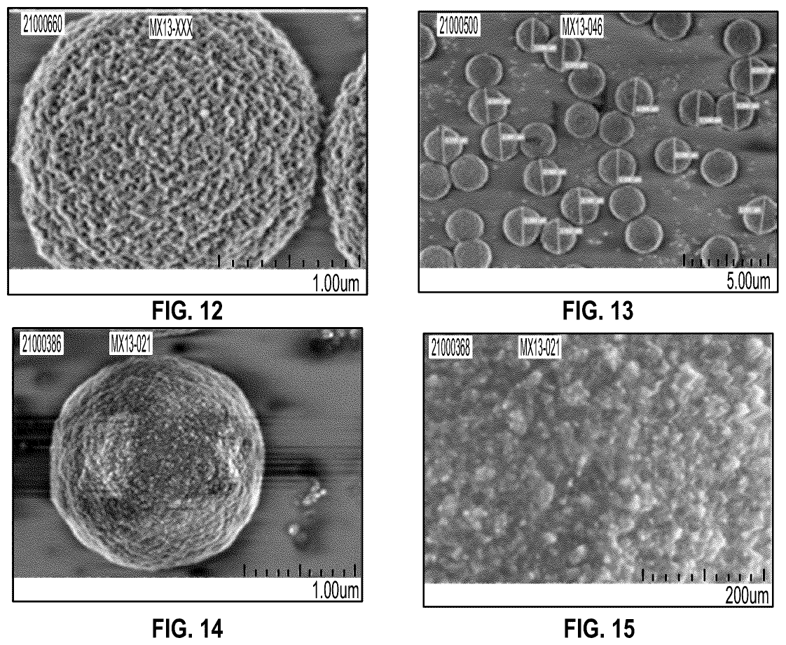

Table 3 provides the synthesis of primed particles with different surface morphology and primer layer thickness by adjusting the amount of primer monomer use and the amount of crosslinker DVB80 used in numerous different samples. FIGS. 8-13 show primed particles, in accordance with samples below, with different surface morphology and primer layer thickness. FIGS. 8 and 9 depict the primed particles of the sample 4G. FIGS. 10 and 11 depict the primed particles of the sample 4H. FIGS. 12 and 13 depict the primed particles of the sample 4I.

TABLE 3

| | Surface | Pore | Core slurry, g | | | | | | Primer solution, g | | | |
|---|---|---|---|---|---|---|---|---|---|---|---|---|
| | area | volume | Core | Reagent | p- | PVP- | | | | Styryl- | PVP- | Reagent |
| Sample | m²/g | cc/g | particle | alcohol | Xylene | 40 | AIBN | DVB80 | DVB80 | ethyltrimethoxylsilane | 40 | alcohol |
| 4A | 4.8 | 0.015 | 145.0 | 1490.7 | 165.2 | 44.7 | 2.5 | 2.9 | 1.5 | 14.5 | 13.9 | 464.0 |
| 4B | 4.3 | 0.013 | 135.0 | 1387.9 | 153.8 | 41.6 | 2.4 | 2.7 | 1.4 | 13.5 | 13.0 | 432.0 |
| 4C | 1.6 | 0.005 | 145.0 | 1490.7 | 165.2 | 44.7 | 2.5 | 2.9 | 1.5 | 14.5 | 13.9 | 464.0 |
| 4D | 4.6 | 0.014 | 125.0 | 1285.0 | 142.4 | 38.6 | 2.2 | 2.3 | 1.2 | 11.6 | 4.2 | 140.9 |
| 4E | 4.6 | 0.014 | 138.0 | 1387.9 | 153.8 | 41.6 | 2.4 | 2.7 | 1.4 | 13.5 | 13.0 | 432.0 |
| 4F | 6.1 | 0.019 | 130.0 | 1336.4 | 148.1 | 40.1 | 2.3 | 2.6 | 1.3 | 13.0 | 12.5 | 416.0 |
| 4G | 4.2 | 0.014 | 50.0 | 514.0 | 57.0 | 15.4 | 0.9 | 0.9 | 0.5 | 4.7 | 1.7 | 56.4 |
| 4H | 5.1 | 0.015 | 50.0 | 514.0 | 57.0 | 15.4 | 0.9 | 1.8 | 0.9 | 9.0 | 3.6 | 120.0 |
| 4I | 11.6 | 0.039 | 50.0 | 528.8 | 58.6 | 15.9 | 0.9 | 2.5 | 1.3 | 12.7 | 3.0 | 101.3 |

### EXAMPLE 5. CORE SURFACE PRIMED WITH OTHER FUNCTIONALITY

In this example, an exemplary primed, non-porous core is manufactured having various functionality. Other processes and other materials can be utilized for making the primed, non-porous polymer core of the composite particles of the present technology.

Here, referring to sample 5A (shown below), the primer monomer of the primed, non-porous polymer core was replaced. Specifically, the reagent alcohol used in the reaction contains 90% ethanol, ˜5% methanol and ˜5% isopropanol. In this particle synthesis experiment, 15.4 grams of PVP-40 and 57.0 grams of p-xylene were charged into a 1 L round bottom flask reactor equipped with mechanical agitation, a condenser, a reactor, and a thermocouple. A slurry of 50.0 grams of particle made in example 3 in 514.0 grams of reagent alcohol was added. The mixture was mixed at 200 RPM for 24 hours. Then the reaction slurry was purged with nitrogen via sub-surface to obtain a dissolved oxygen below 1 ppm. Once the dissolved oxygen in the solution is less than 1 ppm, the reaction mixture was heated to 70° C. and the agitation speed was adjusted to 75 RPM. Then, 1.8 grams of divinylbenzene and 0.9 grams of 2,2′-Azobis(2-methylpropionitrile) (AIBN) were added. After 15 minutes of mixing, a solution containing 9.0 grams of N-vinyl pyrrolidone, 0.9 grams of divinylbenzene and 3.6 grams of PVP-40 in 120.0 grams of reagent alcohol was added at a constant flow rate over 2 hours. After the reaction was held at 70° C. for a total of 20 hrs, the reaction was cooled to below 40° C. and the produced particles were separated from the reaction slurry by filtration. The particles were washed with methanol, followed with tetrahydrofuran (THF), and lastly with acetone. The final product was dried in vacuum oven at 45° C. overnight. 54.0 grams of primed particles were obtained.

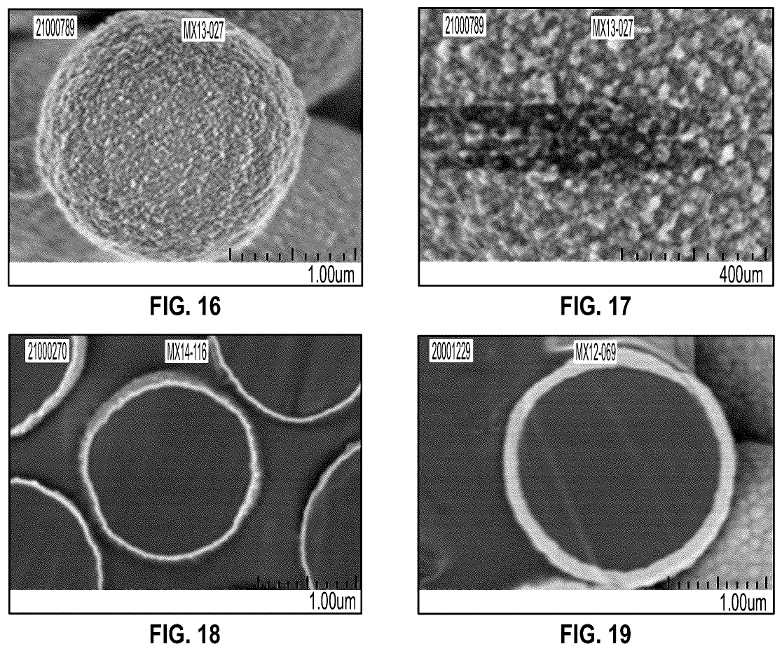

Samples 5A to 5E, shown below, describe the synthesis of primed particles with different surface functionalities. In each sample, the primer monomer was replaced in the formulation of the primed, non-porous polymer core. While the experiment described above utilizes sample 5A, other experiments were performed utilizing samples 5B to 5E. FIGS. 14 and 15 depict a particle prior to priming, and FIGS. 16 and 17 depict the morphology change of the particle of after primed with poly(N-vinyl pyrrolidone).

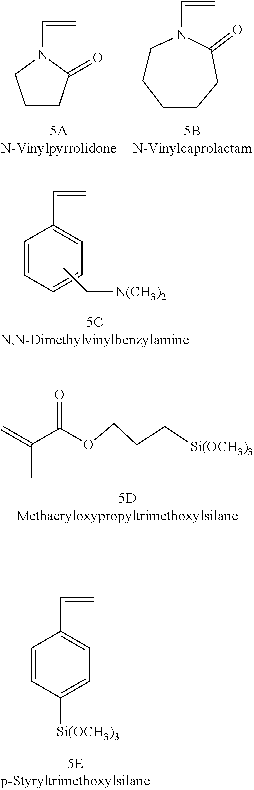

### EXAMPLE 6. NON-POROUS HYBRID COATING ON TRIMETHOXYLSILANE PRIMED CORE

In this example, an exemplary primed, non-porous core with a hybrid coating is manufactured to form a core-shell particle in accordance with the present technology. Other processes and other materials can be utilized for making the primed, non-porous polymer core with a hybrid coating of the composite particles of the present technology.

In this particle synthesis experiment (i.e., to for sample 6A), a 5L round bottom flask reactor equipped with mechanical agitation, a condenser, reactor, and thermocouple, was set up in a sonication bath capable of heating (490 watts). 140.0 grams of silane primed core (sample 4A) was re-dispersed in 1120.0 grams of 200 proof ethanol and then charged into reactor. 1120.0 grams of toluene and 26.9 grams of Pluronic F127 and 77.1 grams of ammonium hydroxide (28-30% aqueous solution) were added to the slurry of the reactor. The temperature of the sonication bath was raised to 35° C. and start sonication. The sonication was maintained through the entire coating process. When the sonication bath temperature reached 35° C., a solution containing 98.2 grams of tetraethyl orthosilicate (TEOS), 41.8 grams of 1,2-bis(triethoxysilyl), ethane (BTEE), 3.5 grams of Pluronic F127 in a mixed solvent of 70.0 grams of ethanol (200 proof), and 70.0 grams of toluene, was metered into the reactor at a constant flow rate over 6 hours. After the addition, the reaction was held at 35° C. for 24 hours. The coated were isolated by filtration and washed with methanol for 6 times. The final product was dried in vacuum oven at 70° C. overnight. 174.0 grams of non-porous BEH coated particles (i.e., sample 4A particles coated with non-porous BEH material) were obtained.

Table 4 below provides the synthesis of non-porous hybrid coated particle with different coating thickness and surface morphology by adjusting the amount of TEOS, BTEE and the use or not use of surfactant (samples 6A-6H). FIGS. 18 and 19 depict the non-porous hybrid coated particle of samples 6D and 6H, respectively, showing hybrid coated particles with different coating thickness and surface morphology.

TABLE 4

| | Surface | Pore | Particle | Coating | | | | | |
|---|---|---|---|---|---|---|---|---|---|
| Example | area | volume | szie | thickness | Primed core particle | | | Coating monomer | |
| 6 | m²/g | cc/g | μm | nm | ID | Charge, g | Surfactant | TEOS, g | BTEE, g |
| 6A | 4.8 | 0.011 | 2.05 | 48.5 | example 4A | 140 | Pluronic F127 | 98.2 | 41.8 |
| 6B | | | | 190.0 | example 4F | 130 | No surfactant | 284.2 | 120.8 |
| 6C | | | | 67.0 | example 4E | 130 | No surfactant | 134.5 | 57.2 |
| 6D | 4.2 | 0.011 | 2.23 | 50.0 | example 4D | 40 | Pluronic F127 | 28.1 | 11.9 |
| 6E | 4.4 | 0.010 | 2.25 | 51.0 | example 4B | 90 | Pluronic F127 | 63.2 | 26.9 |
| 6F | 5.3 | 0.012 | 1.91 | 31.0 | example 4C | 90 | Pluronic F127 | 63.2 | 26.9 |
| 6G | 4.1 | 0.029 | | 175.0 | | 3 | PE-block-PEO, Mw = 1400 | 8.0 | 2.0 |
| 6H | 5.7 | 0.007 | | 178.0 | | 3 | Triton X-100 | 8.0 | 2.0 |

### EXAMPLE 7. NON-POROUS HYBRID COATING ON PYRROLIDONE PRIMED CORE

In this example, an exemplary primed (primed with pyrrolidone), non-porous core with a hybrid coating is manufactured. Other processes and other materials can be utilized for making the primed, non-porous polymer core with a hybrid coating of the composite particles of the present technology.

A 5 L round bottom flask reactor equipped with mechanical agitation, a condenser, reactor, and thermocouple were set up in a sonication bath capable of heating (490 watts). 14.0 grams of pyrrolidone primed core (sample 5A) was re-dispersed in 112.0 grams of 200 proof ethanol and then charged into reactor. 112.0 grams of toluene, 2.7 grams of Pluronic F127 and 7.7 grams of ammonium hydroxide (28-30% aqueous solution) were added to the slurry of the reactor. The sonication bath temperature was raised to 35° C. for sonication. The sonication was maintained through the entire coating process. When the sonication bath temperature reached 35° C., a solution containing 9.8 grams of tetraethyl orthosilicate (TEOS), 4.2 grams of 1,2-bis(triethoxysilyl) ethane (BTEE), 0.4 grams of Pluronic F127 in a mixed solvent of 7.0 grams of ethanol (200 proof), and 7.0 grams of toluene was metered into the reactor at a constant flow rate over 6 hours. After the addition, the reaction was held at 35° C. for 24 hours. The coated particles were isolated by filtration and washed with methanol for 6 times. The final product was dried in vacuum oven at 70° C. overnight. 16.0 grams of non-porous BEH coated particles were obtained.

### EXAMPLE 8. POROUS HYBRID SHELL GROWTH ON A POLYMER CORE COATED WITH NON-POROUS HYBRID MATERIAL

In this example, a non-porous core with a non-porous hybrid coating and a porous hybrid shell is manufactured. Other processes and other materials can be utilized for making the primed, non-porous polymer core with a hybrid coating of the composite particles of the present technology.

5.0 grams of non-porous hybrid coated core (example 6A, 2.05 μm) was dispersed in 306.8 grams of ethanol and 150.8 grams of water with 9.0 grams of Pluronic P123 in a 1 L round-bottom flask equipped with mechanical agitation, condenser and thermocouple. The temperature of the reaction slurry was raised to 46° C. and agitation speed was adjusted to 150 RPM. A solution was prepared by dissolving 5.7 grams of Pluronic P123 in a binary solvent of 113.6 grams of ethanol and 100.5 grams of water, followed by addition of an organic mixture containing 12.1 grams of N,N-Dimethylhexadecylamine, 14.03 grams of tetraethyl orthosilicate (TEOS), 5.97 grams of 1,2-Bis(triethoxysilyl)ethane (BTEE) and 36.0 grams of toluene. The solution was emulsified by sonication and the obtained emulsion was mixed at ambient temperature for 60 minutes. After 60 minutes mixing, the emulsion was added to the reaction and the reaction is continued at 46° C. for 24 hours. After reaction, the particles were isolated by filtration and washed with methanol three times. The particles were further aged at 55° C. for 24 hours in a solution containing 135.0 grams of ethanol, 122.0 grams of water and 30.0 grams ammonium hydroxide (28-30%, wt). After dried in a vacuum oven at 45° C. overnight, 9.9 grams of 2.85 micrometer aged core shell particles were obtained. These particles had an average pore diameter of 57 Å, a surface area of 212.7 m²/g, and a pore volume of 0.34 cc/g measured by a nitrogen adsorption porosimeter.

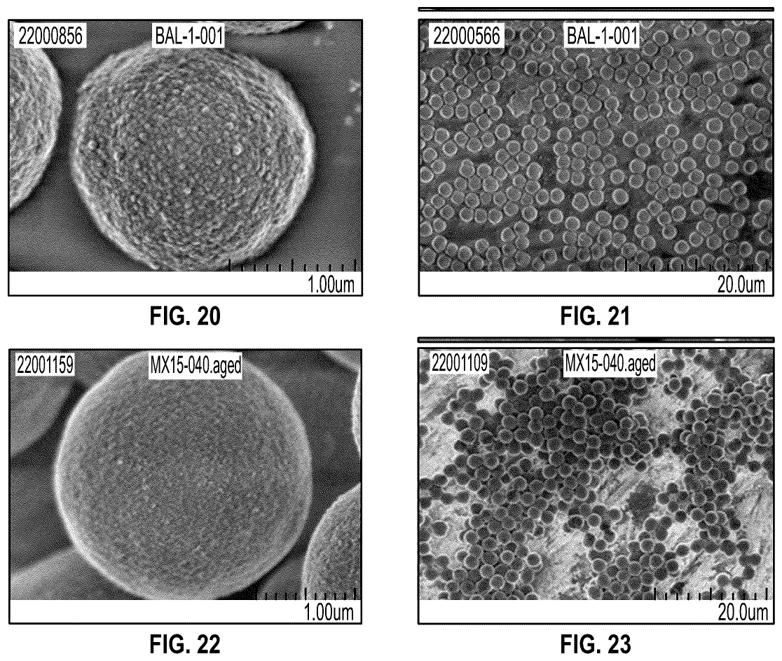

FIGS. 20 and 21 depict the surface morphology of the non-porous hybrid coated particle of sample 6A. FIGS. 22 and 23 depict the surface morphology of a porous hybrid coated particle of example 6A.

### EXAMPLE 9. ENLARGEMENT OF PORE SIZE OF POROUS SHELL

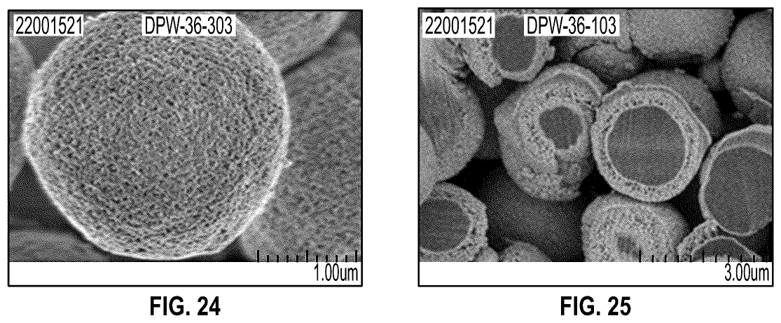

To increase the size of the pores within the shell, 8 grams of the resulting particles (example 8) were dispersed in 100 ml of 0.3 M Trizma buffer with a pH=9.8 adjusted with acetic acid. The slurry was transferred into an autoclave reactor and the autoclave reactor was sealed. The pore enlargement was performed by mixing the reaction slurry at 200° C. for 18 hours. After 18 hours, the particles were isolated by filtration and washed with Milli-Q water until the collected filtrate is neutral. The, the particle is further washed with acetone for three times and dried under vacuum oven at 70° C. overnight. The dried particles were treated with acid by refluxing in 1M hydrogen chloride overnight. The particles were isolated again by filtration and washed with water until filtrate is neutral. Finally, the particles were washed with acetone for three times and dried under vacuum oven at 70° C. overnight. The obtained particle has an average pore size of 370 A and a pore volume of 0.31 cc/g as measured by a nitrogen porosimeter. A comparison of the pore volume and average pore size of the particles of example 9 to example 8 illustrates the enlargement of pores achieved using the techniques described in example 9. FIG. 24 is an SEM image of a resulting particle of example 9. FIG. 25 is an SEM image of a cross-section of resulting particles of example 9.

### EXAMPLE 10. C18 BONDED PHASE ON HYBRID POROUS SHELL

In this example, a bonding material (i.e., C18 bonded phase) is added to the exterior surface of the hybrid porous shell. To make such core-shell particles, 7.5 grams of particles described in example 10 were dispersed in toluene (10 mL/g) under anhydrous conditions with octyldecyltrichlorosilane (tC18). A catalyst (Imidazole; 10 μmol/m²) was added with the latter. The reaction was heated to 110° C. for 20 h, then cooled to room temperature (RT). The particles were isolated via filtration then washed with toluene, acetone, and water. Following the bonding reaction, hydrolysis was performed using ammonium bicarbonate (100 mM) and acetone (40:60 v/v) at 50° C. for 2 h. The reaction was cooled to RT and the particles were isolated via filtration. The particles were then washed with toluene, acetone, and water then dried under vacuum at 70° C. for 16 h. Remaining surface silanols were endcapped using a combination of (N,N-dimethylamino)triethylsilane (TES; 5 μmol/m²) and (N,N-dimethylamino)trimethylsilane (TMS; 8 μmol/m²) in toluene (10 mL/g) for 4 h at 110° C. Particles were isolated via filtration then washed with toluene, acetone, and water and dried under vacuum at 70° C. for 16 h.

### EXAMPLE 11. CHROMATOGRAPHY SEPARATION OF SMALL MOLECULES ON C18 BONDED HYBRID CORE SHELL PARTICLE

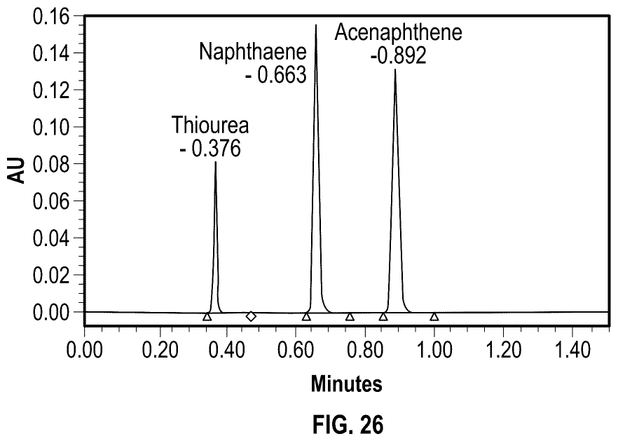

FIG. 26 is a chromatogram of an isocratic reverse phase separation of thiourea, naphthalene and acenaphthene using a column packed with particles from example 10 as the stationary phase. A 2.1 mm (ID)×50 mm (Length) column was packed with particle described in example 10. An isocratic reverse phase separation of a mixture of 0.01 mg/ml thiourea, 0.10 mg/ml naphthalene and 0.20 mg/ml acenaphthene was then performed on a UPHPLC system (Waters Acquity UPLC system, available from Waters Corporation, Milford, MA). An injection volume of 0.3 μL, at a flow rate of 0.25 ml/min, at a temperature of 30° C. using a mobile phase of acetonitrile/water (60/40, v/v). High efficiency separation was achieved with symmetric peak shape as can be seen in FIG. 26. Peak results of the thiourea peak are as follows a RT of 0.376, a USP plates of 7696, a RPH of 2.71, a USP tailing number of 1.107, K prime of 0 at a column psi of 1800. Peak results of the naphthalene peak are as follows a RT of 0.663, a USP plates of 11101, a RPH of 1.81, a USP tailing number of 1.203, K prime of 0.763 at a column psi of 1800. Peak results of the acenaphthene peak are as follows a RT of 0.892, a USP plates of 12025, a RPH of 1.73, a USP tailing number of 1.174, K prime of 1.373 at a column psi of 1800.

### EXAMPLE 12. CHROMATOGRAPHY SEPARATION OF dsDNA ON C18 BONDED HYBRID CORE SHELL PARTICLE

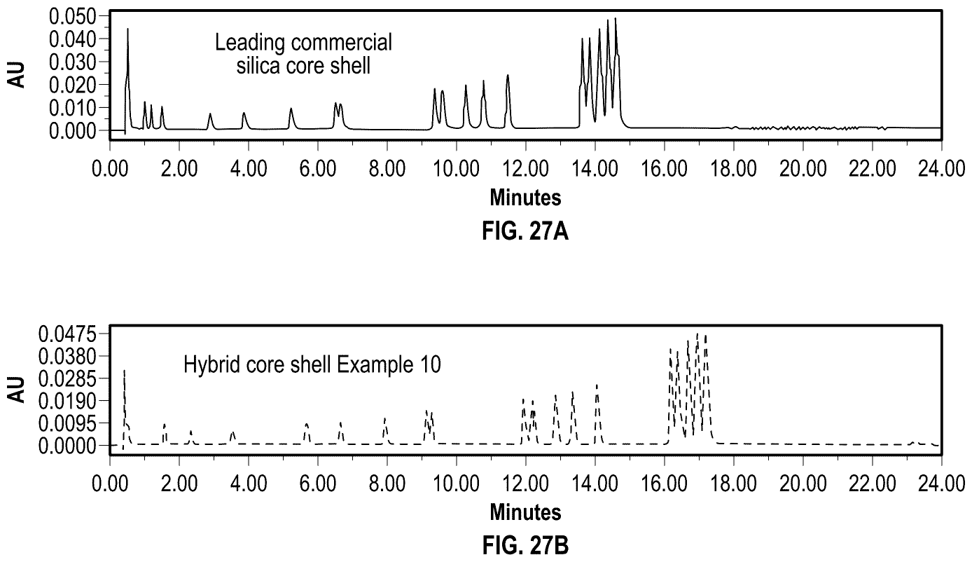

In this example, another small molecule sample was separated using the resulting particles from example 10. A 2.1 mm (ID)×50 mm (Length) column was packed with particle described in example 10. A gradient ion-pairing reverse phase separation of a 18 fragments dsDNA sample was performed on a Waters Acquity UPLC system. To test the results of the present particles, the same sample was separated using the same conditions and system—the only difference was the type of particle used: example 10 particles vs. silica based core shell particles. Compared to the leading commercial silica based core shell particle packed column, the column packed with example 10 showed superior separation performance. Compare FIG. 27A (silica core shell particle) to FIG. 27B, core-shell particle of example 10.

The following conditions were used for both the silica core separation and the example 10 particle separation: column temperature was set to 50° C., a flow rate of 0.2 ml/min was used to deliver the sample, the mobile phase was delivered as a gradient with mobile phase A being 0.1 M TEAA, at a pH of 7 and mobile phase B being 20% acetonitrile in mobile phase A. The gradient was 57.5 to 84.5 B in 20 minutes. A PDA detector at 260 nm was used to capture the results.

### EXAMPLE 13. BASE STABILITY OF C18 BONDED HYBRID CORE SHELL PARTICLE

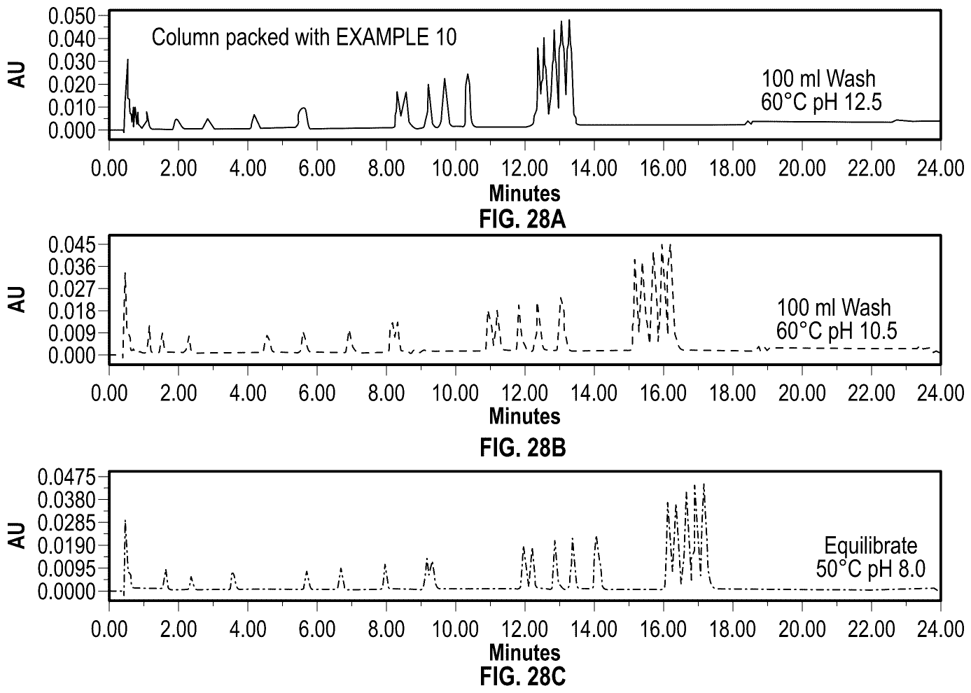

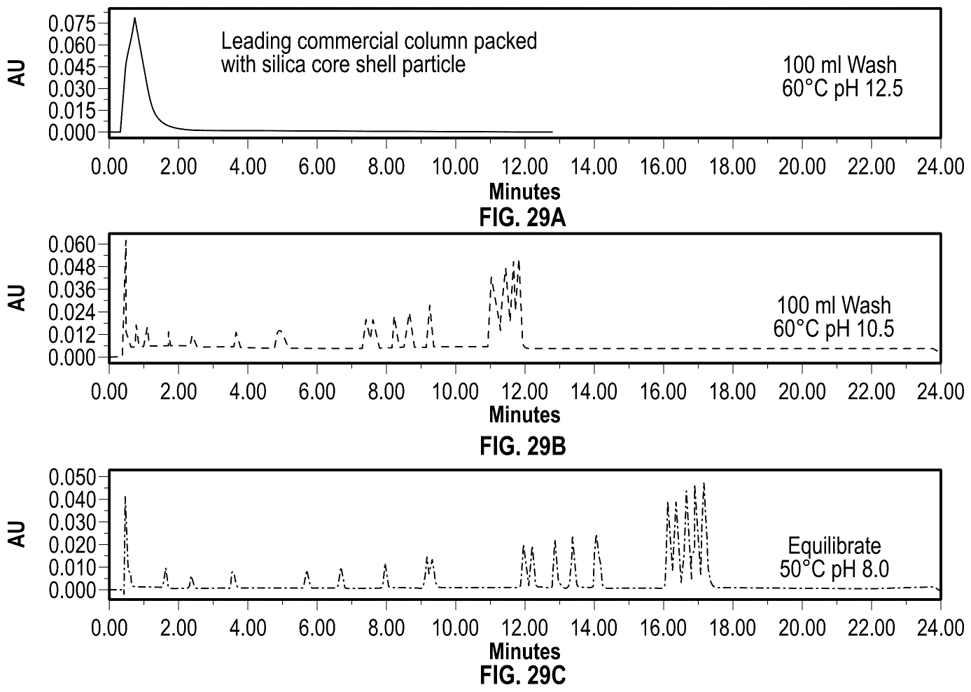

In addition to comparing chromatography results between example 10 particles and silica core shell particles (see example 12), base stability was also evaluated. In this example, a 2.1 mm (ID)×50 mm (Length) column was packed with particle described in example 10. The column was treated by (1) flowing pH=8.0 buffer through the column at a flow rate of 0.2 ml/min for 15 hour; (2) flowing pH=10.5 buffer through the column at a flow rate of 0.2 ml/min for 15 hour; (3) flowing pH=12.5 buffer through the column at a flow rate of 0.2 ml/min for 15 hour. At the end of each treatment, a gradient ion-pairing reverse phase separation of a 18 fragments dsDNA sample was performed on a Waters Acquity UPLC system. The column packed with example 10 showed minimum loss of separation performance with pH=10.5 treatment. The same three treatments were allied to a 2.1 mm (ID)×50 mm (Length) column packed with silica core shell particles. While the leading commercial silica based core shell particle packed column (at the pH=10.5 treatment) showed significant reduced retention time, it provided much poorer resolution than the core-shell particles of example 10. The column packed with example 10 after exposure to pH=12.5 at 50° C. for 15 hours still showed good separation of all 18 dsDNA fragments. As a comparison, the silica based core shell particle packed column lost separation completely when the column was treated at the same condition. FIGS. 28A, 28B, and 28C provide the results for the three different treatments for particles of example 10; whereas FIGS. 29A, 29B, and 29C provide the results for the three different treatments for the silica core-shell particles.

1. A core-shell particle comprising:
a non-porous polymer particle core having a modified surface;
a non-porous hybrid organic-inorganic material in contact with the modified surface; and
a porous hybrid organic-inorganic shell material in contact with the non-porous hybrid organic-inorganic material.

2. The particle of claim 1, wherein the non-porous polymer particle core is made from a radical polymerizable monomer or monomers.

3. The particle of claim 2, wherein the non-porous polymer particle core is made from styrene, divinylbenzene, methacrylate, or acrylonitrile.

4. The particle of claim 1, wherein the non-porous polymer particle core is made from a monomer or monomers containing at least two functional groups.

5. The particle of claim 2, wherein the non-porous polymer particle is made from monomers by condensation.

6. The particle of claim 5, wherein the monomers are carboxylic acid/alcohol or carboxylic acid/amine.

7. The particle of claim 1, wherein the non-porous polymer particle core is made from a monomer or monomers that can be polymerized by ring opening polymerization.

8. The particle of claim 7, wherein the monomers are epoxides.

9. The particle of claim 1, wherein at least a portion of the modified surface of the non-porous polymer particle core comprises at least a functional group covalently bonded to the non-porous hybrid organic-inorganic material to form a functionalized surface.

10. The particle of claim 9, wherein the functional group is at least one of organosilane, organotitanium, organozirconium characterized by C—Si, C—Ti and C—Zr bond.

11. The particle of claim 1, wherein at least a portion of the modified surface of the non-porous polymer particle core comprises at least a functional group electrostatically interacting with the non-porous hybrid organic-inorganic material to form a functionalized surface.

12. The particle of claim 11, wherein the functional group is an amide.

13. The particle of claim 1, wherein the non-porous hybrid organic-inorganic material has a thickness in the range of about 10 nm to about 200 nm.

14. The particle of claim 1, wherein the non-porous hybrid organic-inorganic material has a thickness in the range of about 25 nm to about 100 nm.

15. The particle of claim 1, wherein the non-porous hybrid organic-inorganic material has a pore volume less than 0.1 cc/g.

16. The particle of claim 1, wherein the non-porous hybrid organic-inorganic material comprises at least one of silica, alumina, titanium, cerium, zirconium, zirconium oxide, or a ceramic material.

17. The particle of claim 1, wherein the non-porous hybrid organic-inorganic material comprises a silicon-based hybrid organic-inorganic material.

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)
